(19) United States
(12) Patent Application Publication
(10) Pub. No.: US 2026/0273422 A1
(43) Pub. Date: Sep. 17, 2026

(54) INTERACTION PROCESSING METHOD

(71) Applicant: TENCENT TECHNOLOGY (SHENZHEN) COMPANY LIMITED, Shenzhen (CN)

(72) Inventor: Zequan ZHANG, Shenzhen (CN)

(73) Assignee: TENCENT TECHNOLOGY (SHENZHEN) COMPANY LIMITED, Shenzhen (CN)

(21) Appl. No.: 19/677,039

(22) Filed: May 14, 2026

Related U.S. Application Data
(63) Continuation of application No. PCT/CN2025/109107, filed on Jul. 17, 2025.

(30) Foreign Application Priority Data
Aug. 20, 2024 (CN) 202411148544.2

(51) Int. Cl. A63F 13/837; A63F 13/5375; A63F 13/573

(52) U.S. Cl. CPC A63F 13/837; A63F 13/5375; A63F 13/573

(57) ABSTRACT

In an interaction processing method for a virtual scene, the virtual scene of a game application is displayed and a reticle of a shooting prop is displayed at a first position. A reticle of a shooting prop is moved from the first position to a second position based on an adjustment operation. Whether a distance between the second position of the reticle and the first virtual object satisfy a distance condition is determined. A first predicted movement trajectory of a first virtual object is displayed based on the distance between the second position of the reticle and the first virtual object satisfying a distance condition. A first attack prompt identifier is displayed at a first end position of the first predicted movement trajectory, the first virtual object being predicted to reach the first end position based on a current movement state.

### CROSS-REFERENCE TO RELATED APPLICATIONS

The present application is a continuation of International Application No. PCT/CN2025/109107, filed on Jul. 17, 2025, which claims priority to Chinese Patent Application No. 202411148544.2, filed on Aug. 20, 2024. The entire disclosures of the prior applications are hereby incorporated by reference.

### FIELD OF THE TECHNOLOGY

This disclosure relates to artificial intelligence technologies, including an interaction processing method and apparatus for a virtual scene, an electronic device, a non-transitory computer-readable storage medium, and a computer program product.

### BACKGROUND OF THE DISCLOSURE

In a virtual scene, when shooting at a fast-moving object using a shooting prop, a user can use a sight of the shooting prop for aiming. However, in related technologies, the sight of the shooting prop is used for simple aiming. During shooting, the user needs to subjectively determine a to-be-shot position based on a moving trajectory of the fast-moving object and a flight trajectory of a projectile of the shooting prop. A long period of practice may be required to hit the target, which requires a high level of shooting ability from the user. On one hand, human-computer interaction efficiency is affected. On the other hand, the long practice time consumes too many resources of the electronic device.

### SUMMARY

Embodiments of this disclosure include an interaction processing method and apparatus for a virtual scene, an electronic device, a non-transitory computer-readable storage medium, and a computer program product, so that human-computer interaction efficiency can be improved, and occupation of resources of an electronic device is reduced.

Technical solutions of the embodiments of this disclosure may be implemented in the following manners.

An embodiment of this disclosure provides an interaction processing method for a virtual scene. In the interaction processing method for a virtual scene, the virtual scene of a game application is displayed and a reticle of a shooting prop is displayed at a first position, the virtual scene including at least one virtual object. A reticle of a shooting prop is moved from the first position to a second position based on an adjustment operation for a shooting direction of the shooting prop performed by a user of the game application. Whether a distance between the second position of the reticle and the first virtual object satisfy a distance condition is determined. A first predicted movement trajectory of a first virtual object of the at least one virtual object is displayed based on the distance between the second position of the reticle and the first virtual object satisfying a distance condition. A first attack prompt identifier is displayed at a first end position of the first predicted movement trajectory, the first virtual object being predicted to reach the first end position based on a current movement state, the first attack prompt identifier being configured to prompt the user to attack the first end position by using the shooting prop.

An embodiment of this disclosure provides an interaction processing apparatus. The interaction processing apparatus includes processing circuitry configured to display a virtual scene of a game application and a reticle of a shooting prop at a first position, the virtual scene including at least one virtual object. The processing circuitry is configured to move a reticle of a shooting prop from the first position to a second position based on an adjustment operation for a shooting direction of the shooting prop performed by a user of the game application. The processing circuitry is configured to determine whether a distance between the second position of the reticle and the first virtual object satisfy a distance condition. The processing circuitry is configured to display a first predicted movement trajectory of a first virtual object of the at least one virtual object based on the distance between the second position of the reticle and the first virtual object satisfying a distance condition. The processing circuitry is configured to display a first attack prompt identifier at a first end position of the first predicted movement trajectory, the first virtual object being predicted to reach the first end position based on a current movement state, the first attack prompt identifier being configured to prompt the user to attack the first end position by using the shooting prop.

An embodiment of this disclosure provides a non-transitory computer-readable storage medium storing instructions which when executed by a processor cause the processor to perform the interaction processing method.

An embodiment of this disclosure provides an interaction processing method for a virtual scene, the method being performed by an electronic device, and including: displaying a virtual scene, the virtual scene including a shooting prop and at least one virtual object; updating, in response to an adjustment operation for a shooting direction of the shooting prop, a position of a reticle of the shooting prop based on the adjustment operation; displaying a first predicted moving trajectory of a first virtual object in response to that a distance between the reticle and the first virtual object after the adjustment operation satisfies a distance condition; and displaying a first attack prompt identifier at a first end position of the first predicted moving trajectory, the first end position being a position that the first virtual object is to reach when maintaining a current moving state, the first attack prompt identifier being configured for prompting to attack the first end position by using the shooting prop, and the first virtual object being any one of the at least one virtual object.

An embodiment of this disclosure provides an interaction processing apparatus for a virtual scene, the apparatus including: a first display module, configured to display a virtual scene, the virtual scene including a shooting prop and at least one virtual object; a position update module, configured to update, in response to an adjustment operation for a shooting direction of the shooting prop, a position of a reticle of the shooting prop based on the adjustment operation; and a second display module, configured to display a first predicted moving trajectory of a first virtual object in response to that a distance between the reticle and the first virtual object after the adjustment operation satisfies a distance condition; and display a first attack prompt identifier at a first end position of the first predicted moving trajectory, the first end position being a position that the first virtual object is to reach when maintaining a current moving state, the first attack prompt identifier being configured for prompting to attack the first end position by using the shooting prop, and the first virtual object being any one of the at least one virtual object.

An embodiment of this disclosure provides an electronic device, including: a memory, configured to store computer-executable instructions; and a processor, configured to implement, when executing the computer-executable instructions stored in the memory, the interaction processing method for a virtual scene provided in the embodiments of this disclosure.

An embodiment of this disclosure provides a non-transitory computer-readable storage medium, having a computer program or computer-executable instructions stored therein, the computer program or the computer-executable instructions, when being executed by a processor, implementing the interaction processing method for a virtual scene provided in the embodiments of this disclosure.

An embodiment of this disclosure provides a computer program product, including a computer program or computer-executable instructions, the computer program or the computer-executable instructions, when being executed by a processor, implementing the interaction processing method for a virtual scene provided in the embodiments of this disclosure.

The embodiments of this disclosure can have the following beneficial effects.

The shooting direction of the shooting prop in the virtual scene is adjusted to dynamically adjust the position of the reticle, and the shooting direction and the position of the reticle are linked in real time, to address a problem of an aiming delay caused by “direction-reticle separation” in a shooting game in a related technology. A user can automatically synchronize the direction with the reticle without manually calibrating an offset of the reticle, so that operation complexity can be reduced. When a distance between the reticle and a virtual object satisfies the distance condition, a predicted moving trajectory of the virtual object is displayed. Trajectory prediction is triggered based on the distance condition, to implement intelligent aiming assistance, so that the user does not need to estimate a target moving path, and the trajectory is automatically calculated and displayed. In addition, an attack prompt identifier is displayed at an end position of the predicted moving trajectory, so that the predicted moving trajectory of the virtual object and the attack prompt identifier are more intuitively displayed. Depending on an auxiliary effect of the attack prompt identifier, the user can more clearly determine a to-be-shot target position when aiming by using the reticle of the shooting prop. In comparison with the related technology in which aiming is performed by using the reticle of the shooting prop, a user with less shooting experience can more easily hit an object, thereby reducing difficulty in shooting the virtual object, improving human computer interaction efficiency, and reducing occupation of resources of an electronic device.

### BRIEF DESCRIPTION OF THE DRAWINGS

FIG. 1 is a schematic diagram of an architecture of an interaction processing system 100 for a virtual scene according to an embodiment of this disclosure.

FIG. 2 is a schematic diagram of a structure of a terminal 400 according to an embodiment of this disclosure.

FIG. 3A is a first schematic flowchart of an interaction processing method for a virtual scene according to an embodiment of this disclosure.

FIG. 3B is a schematic flowchart of updating a position of a reticle according to an embodiment of this disclosure.

FIG. 3C is a first schematic flowchart of determining a first end position according to an embodiment of this disclosure.

FIG. 3D is a second schematic flowchart of determining a first end position according to an embodiment of this disclosure.

FIG. 3E is a second schematic flowchart of an interaction processing method for a virtual scene according to an embodiment of this disclosure.

FIG. 3F is a schematic flowchart of obtaining a target attack prompt identifier according to an embodiment of this disclosure.

FIG. 3G is a third schematic flowchart of an interaction processing method for a virtual scene according to an embodiment of this disclosure.

FIG. 4 is a first schematic diagram of display of a virtual scene according to an embodiment of this disclosure.

FIG. 5A is a second schematic diagram of display of a virtual scene according to an embodiment of this disclosure.

FIG. 5B is a third schematic diagram of display of a virtual scene according to an embodiment of this disclosure.

FIG. 5C is a fourth schematic diagram of display of a virtual scene according to an embodiment of this disclosure.

FIG. 5D is a fifth schematic diagram of display of a virtual scene according to an embodiment of this disclosure.

FIG. 5E is a sixth schematic diagram of display of a virtual scene according to an embodiment of this disclosure.

FIG. 5F is a seventh schematic diagram of display of a virtual scene according to an embodiment of this disclosure.

FIG. 6 is a first schematic diagram of interaction in a virtual scene according to an embodiment of this disclosure.

FIG. 7 is a second schematic diagram of interaction in a virtual scene according to an embodiment of this disclosure.

FIG. 8 is a third schematic diagram of interaction in a virtual scene according to an embodiment of this disclosure.

FIG. 9A is a fourth schematic diagram of interaction in a virtual scene according to an embodiment of this disclosure.

FIG. 9B is a fifth schematic diagram of interaction in a virtual scene according to an embodiment of this disclosure.

FIG. 9C is a sixth schematic diagram of interaction in a virtual scene according to an embodiment of this disclosure.

FIG. 9D is a seventh schematic diagram of interaction in a virtual scene according to an embodiment of this disclosure.

FIG. 10A is an eighth schematic diagram of interaction in a virtual scene according to an embodiment of this disclosure.

FIG. 10B is a ninth schematic diagram of interaction in a virtual scene according to an embodiment of this disclosure.

FIG. 10C is a tenth schematic diagram of interaction in a virtual scene according to an embodiment of this disclosure.

FIG. 11 is a flowchart of interaction processing for a virtual scene according to an embodiment of this disclosure.

FIG. 12 is an eleventh schematic diagram of interaction in a virtual scene according to an embodiment of this disclosure.

The foregoing “first” and “second” are only used to distinguish different solutions, and do not represent superiorities of the solutions or priorities in an implementation process.

### DETAILED DESCRIPTION

To make the objectives, technical solutions, and advantages of this disclosure clearer, the following describes this disclosure in further detail with reference to the accompanying drawings. The described embodiments are not to be considered as a limitation on this disclosure. All other embodiments obtained by a person of ordinary skill in the art shall fall within the scope of this disclosure.

In the following descriptions, “some embodiments” are involved, and a subset of all possible embodiments is described. However, “some embodiments” may be a same subset or different subsets of all the possible embodiments, and may be combined with each other without conflict.

The term “first/second/third” involved in the following descriptions is merely for distinguishing similar objects, and does not represent a specific order of the objects. “First/second/third” may be interchanged in a specific order or sequence when permitted, so that embodiments of this disclosure described herein can be performed in a sequence other than those illustrated or described herein.

In the embodiments of this disclosure, the term “module” or “unit” refers to a computer program or a part of a computer program with a predetermined function, which works together with other related parts to achieve a predetermined objective, and may be implemented using software, hardware (such as a processing circuit or a memory), or a combination thereof. Similarly, a processor (or a plurality of processors or memories) may be configured to implement one or more modules or units. In addition, each module or unit may be a part of an integral module or unit including a function of the module or unit.

Unless otherwise specified, “at least one” below means one or more, and “a plurality of” means two or more.

In an example, “at least one of A, B, or C” is intended to mean any one or a combination of A, B, and C, including A alone, B alone, C alone, A and B, A and C, B and C, or A, B, and C. Further, “one of A and B” includes A, B, or both.

Unless otherwise defined, all technical and scientific terms used in the embodiments of this disclosure have the same meanings as those commonly understood by a person skilled in the art. Terms used in the embodiments of this disclosure are only intended to describe the embodiments of this disclosure, and are not intended to limit this disclosure.

Descriptions of terms in this disclosure are provided as examples only and are not intended to limit the scope of the disclosure.

(1) Virtual scene: The virtual scene may be a scene displayed (or provided) when an application is run on a terminal device. The scene may be a simulation environment of a real world, or may be a semi-simulation and semi-fictional virtual environment, or may be a fictional virtual environment. For example, the virtual scene may be a game scene in a game battle of a user. The scene may include a player character, a non-player character, the sky, the land, the ocean, and the like. The land may include an environment element such as a desert or a city. The user may control the player character to interact with another player character or non-player character in the virtual scene.

(2) Virtual object: The virtual object may be an image of a person or an object that can interact in a virtual scene, or a movable object in the virtual scene. The movable object may be a virtual character, a virtual animal, a moving object, or the like. For example, the virtual object may be a person, an animal, or a vehicle displayed in the virtual scene. The virtual scene may include a plurality of virtual objects. Each of the virtual objects has a shape and a volume in the virtual scene, and occupies a part of space in the virtual scene. For example, the virtual object may be an airplane moving at a high velocity in a virtual scene in a game scene, for a user to shoot by using a shooting prop in the virtual scene.

(3) Predicted moving trajectory: The predicted moving trajectory may be a trajectory obtained by predicting, before a virtual object is shot, a moving trajectory of the virtual object based on a current moving state (a moving velocity and a moving direction) of the virtual object when the virtual object maintains the current moving state.

(4) Attack prompt identifier: The attack prompt identifier may be an identifier identifying a target position attacked by using a shooting prop, and is configured for prompting a user to shoot, by using the shooting prop, the position corresponding to the attack prompt identifier.

(5) “In response to”: configured for representing a condition or state on which a performed operation depends. When the condition or state is satisfied, one or more performed operations may be in real time or may have a set delay. Unless otherwise specified, an execution sequence of the plurality of performed operations is not limited.

(6) Shooting prop: The shooting prop may be a prop simulated in a virtual environment for shooting, such as a virtual artillery, a virtual firearm, an arrow, or another virtual shooting weapon. The props can have characteristics that simulate corresponding items in the real world, including appearances, weights, and feedback effects during shooting.

(7) Reticle: The reticle may be a visual mark (such as a crosshair, a dot, or a dynamic circle) superimposed on a graphical interface (such as a center of a screen), and is configured for indicating an intersection point between a current shooting direction of a shooting prop and a trajectory. A position of the reticle is calculated and synchronized in real time by a server based on an adjustment operation of a user.

(8) Graphical interface: The graphical interface may be configured for representing a virtual scene interface, for example, representing a graphical user interface (GUI), such as an augmented reality (AR) interface, a virtual reality (VR) interface, a voice user interface (VUI), an interactive projection interface (on which information is displayed on a plane by using a projection technology), an eye tracking interface (which is an interface controlled by detecting a line of sight of a user), a holographic interface (a three-dimensional holographic image formed by projecting an image by using a holographic projection technology, where a stereoscopic image can be seen without wearing special glasses), a multimodal user interface (MUI) (which is an interactive interface on which a plurality of interaction manners are combined, such as touch, sight, and hearing), or a brain-machine interface (BMI).

In a virtual scene, when shooting, by using a shooting prop, an object moving at a high velocity, a user can perform aiming and shooting by using a sight of the shooting prop. However, in a related technology, simple aiming is performed by using the sight of the shooting prop. The user needs to subjectively determine a to-be-shot position based on a moving trajectory of the object moving at the high velocity and a flight trajectory of a projectile of the shooting prop. A long period of practice may be required to hit the target, which requires a high level of shoot capability from the user. As a result, user experience may be poor.

Based on the foregoing analysis, in an interaction processing method for a virtual scene in a related technology, a user needs to perform the long period of practice to hit an object moving at a high velocity, which requires a high level of shoot capability from the user. As a result, user experience may be poor. In view of the foregoing problem, an embodiment of this disclosure provides an interaction processing method for a virtual scene, so that difficulty in shooting a virtual object can be reduced, and user experience is improved.

In view of the foregoing problem, the embodiments of this disclosure provide interaction processing methods and apparatuses for a virtual scene, electronic devices, non-transitory computer-readable storage media, and computer program products, so that difficulty in shooting a virtual object can be reduced, and user experience is improved. The following describes an example of the electronic device provided by the embodiments of this disclosure. The electronic device provided by the embodiments of this disclosure may be implemented as various types of terminals such as a laptop computer, a tablet computer, a desktop computer, a set-top box, a smart phone, a smart speaker, a smart watch, a smart television, and a vehicle-mounted terminal, or may be implemented as a server. An example in which the electronic device is implemented as a terminal is described below.

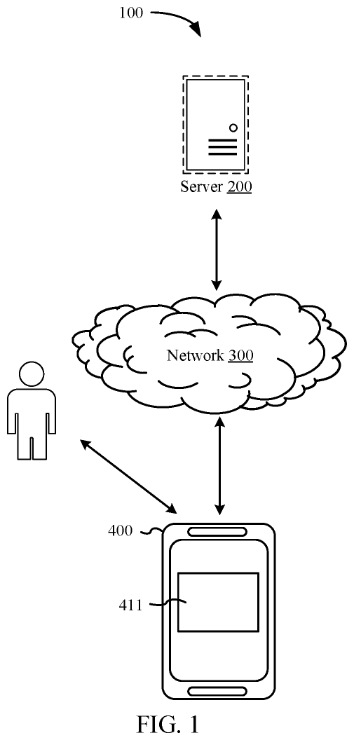

FIG. 1 is a schematic diagram of an architecture of an interaction processing system 100 for a virtual scene according to an embodiment of this disclosure. To support an interaction processing application. For a virtual scene, a terminal 400 (for example, a graphical interface 411 is shown) is connected to a server 200 through a network 300. The network 300 may be a wide area network or a local area network, or a combination thereof.

Using a game scene as an example, the terminal 400 is configured to obtain an operation request of a user, and display a virtual scene on the graphical interface 411, where the virtual scene includes a shooting prop and at least one virtual object. When receiving an adjustment operation performed by the user for a shooting direction of the shooting prop, the terminal 400 sends the adjustment operation to the server 200 through the network 300. The server 200 updates a position of a reticle of the shooting prop based on the adjustment operation, sends the position to the terminal 400, and displays the reticle on the graphical interface 411. When a distance between the reticle and a first virtual object satisfies a distance condition, a first predicted moving trajectory of the first virtual object is displayed, and a first attack prompt identifier is displayed at a first end position of the first predicted moving trajectory. When shooting the first attack prompt identifier by using the shooting prop, the user can hit the first virtual object.

In some embodiments, the terminal 400 is configured to obtain the operation request of the user, and display the virtual scene on the graphical interface 411, where the virtual scene includes the shooting prop and the at least one virtual object. When receiving the adjustment operation performed by the user for the shooting direction of the shooting prop, the terminal 400 updates the position of the reticle of the shooting prop based on the adjustment operation, and displays the reticle on the graphical interface 411. When the distance between the reticle and the first virtual object satisfies the distance condition, the first predicted moving trajectory of the first virtual object is displayed, and the first attack prompt identifier is displayed at the first end position of the first predicted moving trajectory. When shooting the first attack prompt identifier by using the shooting prop, the user can hit the first virtual object.

In some embodiments, the server 200 may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service (DNS), a security service, a content delivery network (CDN), big data, and an artificial intelligence platform. The terminal and the server may be connected directly or indirectly in a wired or wireless communication manner. This is not limited in the embodiments of this disclosure.

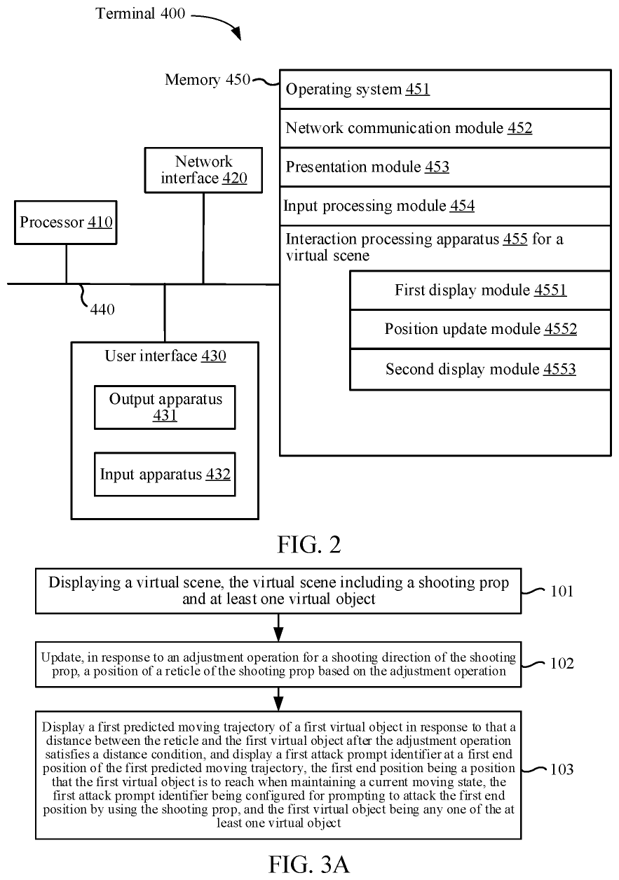

FIG. 2 is a schematic diagram of a structure of a terminal 400 according to an embodiment of this disclosure. The terminal 400 shown in FIG. 2 includes: at least one processor 410, a memory 450, at least one network interface 420, and a user interface 430. All the components in the terminal 400 are coupled together by using a bus system 440. The bus system 440 is configured to implement connection and communication among these components. In addition to a data bus, the bus system 440 further includes a power bus, a control bus, and a status signal bus. However, for clarity of description, various buses are marked as the bus system 440 in FIG. 2.

The processor 410 may be an integrated circuit chip with a signal processing capability, such as a general-purpose processor, a digital signal processor (DSP), or another programmable logic device (PLD), a discrete gate, a transistor logic device, or a discrete hardware component. The general-purpose processor may be a microprocessor, any conventional processor, or the like.

The user interface 430 includes one or more output apparatuses 431 that can represent medium content, and includes at least one of the following: one or more speakers or one or more visual display screens. The user interface 430 further includes one or more input apparatuses 432, including a user interface component facilitating input of a user, such as a keyboard, a mouse, a microphone, a touch display screen, a camera, another input button, or a control.

The memory 450 may be removable, non-removable, or a combination thereof. For example, a hardware device includes a solid-state memory, a hard disk drive, or an optical disk drive. In some embodiments, the memory 450 includes one or more storage devices that are physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of this disclosure is intended to include a memory of any suitable type.

In some embodiments, the memory 450 can store data to support various operations. An example of these data includes a program, a module, and a data structure or a subset or superset thereof. Descriptions are provided below by using an example.

An operating system 451 includes a system program configured for processing various basic system services and performing a hardware-related task, for example, a framework layer, a core library layer, or a driver layer, and is configured for implementing various basic services and processing a hardware-based task.

A network communication module 452 is configured to connect to another electronic device through one or more (wired or wireless) network interfaces 420. For example, the network interface 420 includes Bluetooth, Wi-Fi alliance certification, and universal serial bus (USB).

A presentation module 453 is configured to present information by using one or more output apparatuses 431 (such as display screens or speakers) associated with the user interface 430 (such as a user interface configured to operate a peripheral device and display content and information).

An input processing module 454 is configured to detect one or more user inputs or interactions from one of one or more input apparatuses 432 and translate the detected inputs or interactions.

In some embodiments, the apparatus provided in the embodiments of this disclosure may be implemented by software. FIG. 2 shows an interaction processing apparatus 455 that is for a virtual scene and that is stored in a memory 450. The apparatus may be software in a form of a program and a plug-in, including the following software modules: a first display module 4551, a position update module 4552, and a second display module 4553. The modules are logical and may be combined in different manners or further split based on functions-to-be-implemented. Functions of the modules are described in the following disclosure.

In some embodiments, the terminal may implement the interaction processing method for a virtual scene provided by the embodiments of this disclosure by running various computer-executable instructions or a computer program. For example, the computer-executable instructions may be microprogram-level commands, machine instructions, or software instructions. The computer program may be a native program or a software module in an operating system, may be a native application (APP), namely, a program that needs to be installed in an operating system to run, such as a game APP, or may be a mini program that may be embedded in any APP, namely, a program that only needs to be downloaded into a browser environment to run. To sum up, the foregoing computer-executable instructions may be instructions in any form, and the foregoing computer program may be an application, a module, or a plug-in in any form.

The interaction processing method for a virtual scene provided in the embodiments of this disclosure is described with reference to an exemplary application and implementation of the terminal provided in the embodiments of this disclosure.

The interaction processing method for a virtual scene provided in the embodiments of this disclosure is described below. As mentioned above, the electronic device that implements the interaction processing method for a virtual scene provided in the embodiments of this disclosure may be a terminal, a server, or a combination thereof. Therefore, an execution body for performing each operation is not repeatedly described below.

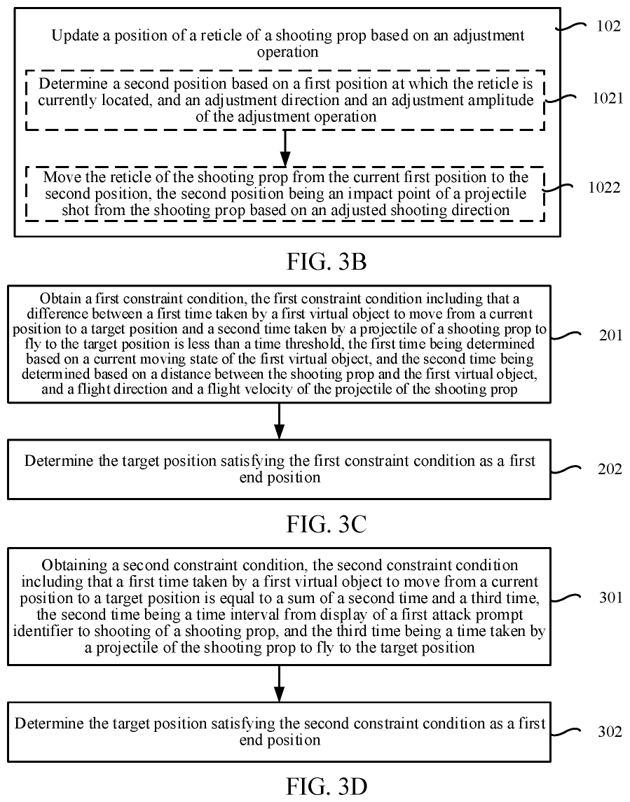

FIG. 3A is a first schematic flowchart of an interaction processing method for a virtual scene according to an embodiment of this disclosure. An example in which a terminal is an execution body is used to describe operations shown in FIG. 3A.

Operation 101: Display a virtual scene, the virtual scene including a shooting prop and at least one virtual object.

In some embodiments, the shooting prop may be a prop simulated in a virtual environment for shooting, such as a virtual artillery, a virtual firearm, an arrow, or another virtual shooting weapon. The props can have characteristics that simulate corresponding items in the real world, including appearances, weights, and feedback effects during shooting. The virtual object is a target that is designed to be shot in the virtual scene. The virtual object may be a virtual person, a target object, or an object that needs to be collected, and may be dynamic, for example, a moving enemy or an object with some automatic reaction mechanisms.

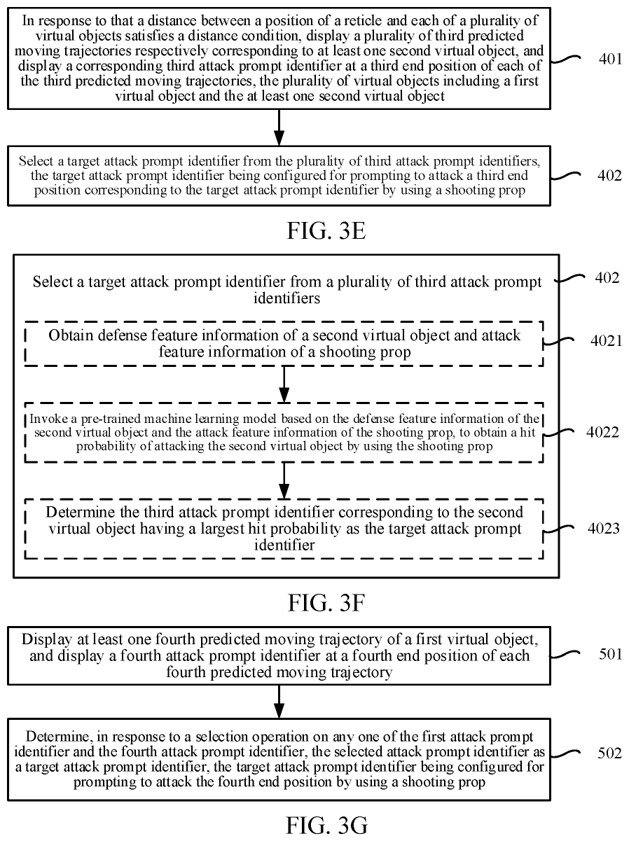

For example, in a game design, the virtual object is set for completing a particular task or challenge, for example, defeating an enemy virtual object in a shooting game, or hitting a particular target in simulation training. FIG. 4 is a first schematic diagram of display of a virtual scene according to an embodiment of this disclosure. As shown in FIG. 4, a shooting prop 461, a reticle 462 configured for aiming, an object 463, and an object 464 are displayed on an interactive interface 460. The object 463 and the object 464 are two different virtual objects on the interactive interface 460.

Operation 102: Update, in response to an adjustment operation for a shooting direction of the shooting prop, a position of a reticle of the shooting prop based on the adjustment operation.

In some embodiments, when receiving the adjustment operation performed by a user for the shooting direction of the shooting prop, the terminal can update the position of the reticle of the shooting prop based on the adjustment operation, and display an updated reticle on a graphical interface of the terminal. In the virtual environment, the adjustment operation for the shooting direction of the shooting prop may be completed through input of the user.

For example, the adjustment operation for the shooting direction of the shooting prop may be a touch operation implemented based on a direction adjustment control (such as a virtual joystick or a direction key) in the virtual scene, or may be a non-touch operation implemented based on a controller, a keyboard, a mouse, or another external input device. When the touch operation performed by the user on the virtual joystick or the direction key in the virtual scene, or the non-touch operation performed by using the controller (such as a gamepad or a steering wheel in a game scene), the keyboard, the mouse, or another input device is detected, the touch operation or the non-touch operation may be converted into the adjustment operation for the shooting direction of the shooting prop. Then, a moving direction of the reticle of the shooting prop in the virtual scene is determined based on an operation direction of the adjustment operation, a moving distance of the reticle of the shooting prop in the virtual scene is determined based on an operation parameter of the adjustment operation, the adjustment operation of the user is converted into actual movement of the reticle of the shooting prop in the virtual scene, and the reticle is displayed in the virtual scene, to update the position of the reticle of the shooting prop.

In some examples, the virtual joystick is displayed as a circular control at a lower left corner or on a right side of a screen in the virtual scene, and the touch operation implemented based on the virtual joystick is completed through contact between a finger of the user and the screen. In response to a press operation performed by the finger on a region in which the virtual joystick is located, a touch sensor of the device can capture a coordinate change of a touch point in real time. For example, during initial touch, a center of the virtual joystick is recorded as a reference point. When a slide operation of the finger is detected, relative displacement (for example, sliding to the upper right by 5 millimeters) between the contact point and the reference point may be calculated in real time.

In some embodiments, FIG. 3B is a schematic flowchart of updating a position of a reticle according to an embodiment of this disclosure. “Update a position of a reticle of the shooting prop based on the adjustment operation” in operation 102 in FIG. 3A may be implemented through operation 1021 and operation 1022 in FIG. 3B. Descriptions are provided below.

Operation 1021: Determine a second position based on a first position at which the reticle is currently located, and an adjustment direction and an adjustment amplitude of the adjustment operation.

In some embodiments, a moving direction of the reticle of the shooting prop may be determined based on an operation direction of the adjustment operation for the shooting direction of the shooting prop; and a moving distance of the reticle of the shooting prop is determined based on an operation parameter of the adjustment operation for the shooting direction of the shooting prop, where the operation parameter of the adjustment operation is positively correlated to the moving distance of the reticle of the shooting prop.

Herein, the adjustment direction is a vector instruction that is triggered by the user by using an input device (a keyboard, a mouse, a gamepad, or the like) and that is configured for changing a current aiming direction of the shooting prop. The direction is mapped to a two-dimensional or three-dimensional displacement direction of the reticle in the virtual scene, and is represented by using an axis of a screen coordinate system or a world coordinate system (for example, “upward” or “to the lower left”). The adjustment amplitude is a continuous or discrete parameter value inputted by the user, and is configured for quantizing a distance by which the reticle moves from the current position (the first position) toward the adjustment direction. The value is positively correlated to an input intensity, and is dynamically adjusted based on a game sensitivity coefficient.

For example, when the shooting direction of the shooting prop is adjusted by using a keyboard, the operation direction of the adjustment operation may be determined by pressing a preset single key or key combination, and the operation parameter of the adjustment operation may be a quantity of times of pressing the single key, or a sequence of pressing the key combination. For example, when a press operation performed by the user on an up arrow “↑” in the keyboard is detected, it indicates that the shooting direction of the shooting prop is adjusted upward, and a distance by which the reticle of the shooting prop is moved upward from the current first position may be determined based on a quantity of times of pressing the up arrow “↑”, to determine the second position of the updated reticle. For example, when it is detected that the quantity of times of pressing the up arrow “↑” by the user is 1, the reticle of the shooting prop may be moved upward from the current first position by 5 centimeters to reach the second position. When it is detected that the quantity of times of pressing the up arrow “↑” by the user is 3, the reticle of the shooting prop may be moved upward from the current first position by 15 centimeters to reach the second position. When a press operation performed by the user on a down arrow “↓” in the keyboard is detected, it indicates that the shooting direction of the shooting prop is adjusted downward, and a distance by which the reticle of the shooting prop is moved downward from the current first position may be determined based on a quantity of times of pressing the down arrow “↓”, to determine the second position of the updated reticle. For example, when it is detected that the quantity of times of pressing the down arrow “↓” by the user is 1, the reticle of the shooting prop may be moved downward from the current first position by 5 centimeters to reach the second position. When it is detected that the quantity of times of pressing the down arrow “↓” by the user is 3, the reticle of the shooting prop may be moved downward from the current first position by 15 centimeters to reach the second position.

Operation 1022: Move the reticle of the shooting prop from the current first position to the second position, the second position being an impact point of a projectile shot from the shooting prop based on the adjusted shooting direction.

For example, still referring to FIG. 4, when the press operation performed by the user on the up arrow “↑” in the keyboard is detected, it indicates that a shooting direction of the shooting prop 461 on the interactive interface 460 is adjusted upward. When it is detected that the quantity of times of pressing the up arrow “↑” in the keyboard by the user is 1, the reticle 462 on the interactive interface 460 is moved from a current first position to a second position of a reticle 472 on the interactive interface 470.

In this embodiment of this disclosure, the position of the reticle of the shooting prop is updated in real time, to ensure that the reticle always points to a position to be hit by the shooting prop. The position of the reticle is linked to the shooting direction in real time (for example, updated in each frame), so that a target when the user shoots the virtual object by using the shooting prop is more real and intuitive, thereby improving shooting accuracy of the user.

Still referring to FIG. 3A, descriptions are continued with operation 102 above.

Operation 103: Display a first predicted moving trajectory of a first virtual object in response to that a distance between the reticle and the first virtual object after the adjustment operation satisfies a distance condition; and display a first attack prompt identifier at a first end position of the first predicted moving trajectory, the first end position being a position that the first virtual object is to reach when maintaining a current moving state, the first attack prompt identifier being configured for prompting to attack the first end position by using the shooting prop, and the first virtual object being any one of the at least one virtual object.

Herein, the distance condition may be that the distance is within a preset distance range. That the distance between the reticle and the first virtual object after the adjustment operation satisfies the distance condition refers to that the distance between the reticle and the first virtual object after the adjustment operation is within the preset distance range.

In some embodiments, when the distance between the reticle and the first virtual object satisfies the distance condition, when the first virtual object maintains the current moving state, the first predicted moving trajectory of the first virtual object may be estimated based on a moving direction and a moving velocity of the current moving state of the first virtual object, and displayed in the virtual scene. The first attack prompt identifier is displayed at the first end position of the first predicted moving trajectory, to prompt to attack the first end position by using the shooting prop.

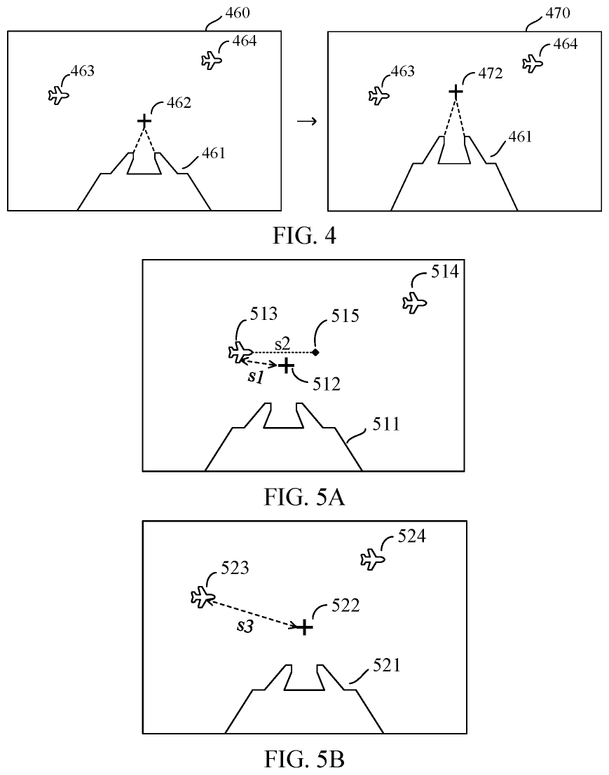

For example, FIG. 5A is a second schematic diagram of display of a virtual scene according to an embodiment of this disclosure. As shown in FIG. 5A, the virtual scene includes a shooting prop 511, a reticle 512 for aiming, a first virtual object 513, and a virtual object 514. A distance between the reticle 512 and the first virtual object 513 is s1. Because s1 satisfies the distance condition, a first predicted moving trajectory of the first virtual object 513 is displayed in the virtual scene in FIG. 5A, and a first attack prompt identifier 515 is displayed at a first end position of the first predicted moving trajectory. As shown in FIG. 5A, the first predicted moving trajectory is a connection line between the first virtual object 513 and the first attack prompt identifier 515, and the first end position of the first predicted moving trajectory is a position of the first attack prompt identifier 515.

In some embodiments, the distance condition in operation 103 includes at least one of the following: the distance between the reticle and the first virtual object is less than a second distance threshold; or the distance between the reticle and the first virtual object is less than the second distance threshold, and a distance between the first attack prompt identifier and the first virtual object is greater than a third distance threshold.

Herein, the second distance threshold and the third distance threshold may be preset with reference to a scene characteristic and an attribute of the virtual object. For example, for an arena scene, to improve a confrontation strategy, the second distance threshold may be more strictly set (set to a small value). For example, in a fast-paced shooting game, display of a trajectory and an identifier is triggered only when a distance between a reticle and a virtual object is less than 5 meters. As a result, a player is required to more precisely aim, so that a prompt does not excessively simplify an operation. The third distance threshold may be set to be slightly greater than an effective anticipation range (for example, 3 meters) of an attack prompt identifier, to ensure that the prompt is considered effective only when a distance between the attack prompt identifier and the virtual object is within a suitable anticipation error. In a casual scene, to lower a threshold for a new player, the second distance threshold may be more loosely set (set to a large value). For example, a prompt is triggered when a distance between a reticle and a virtual object is less than 10 meters, so that a player achieves guidance earlier. The third distance threshold may be properly relaxed, to allow a larger anticipation error (for example, 5 meters), and reduce a prompt failure caused by an unskilled operation.

In some embodiments, when blocking of the first attack prompt identifier by the first virtual object is not considered, only when the distance between the reticle and the first virtual object is less than the second distance threshold, the first predicted moving trajectory of the first virtual object can be displayed in the virtual scene, and the first attack prompt identifier can be displayed at the first end position of the first predicted moving trajectory. In other words, the foregoing distance condition is that the distance between the reticle and the first virtual object is less than the second distance threshold. When blocking of the first attack prompt identifier by the first virtual object is considered, the distance condition may be that the distance between the reticle and the first virtual object is less than the second distance threshold, and the distance between the first attack prompt identifier and the first virtual object is greater than the third distance threshold. In this case, the first predicted moving trajectory of the first virtual object can be displayed in the virtual scene, and the first attack prompt identifier can be displayed at the first end position of the first predicted moving trajectory.

For example, still referring to FIG. 5A, if the second distance threshold is 100 pixels, the third distance threshold is 50 pixels, the distance s1 between the reticle 512 and the first virtual object 513 shown in FIG. 5A is 80 pixels, and a distance s2 between the first virtual object 513 and the first attack prompt identifier 515 is 100 pixels, the distance condition is satisfied, a first predicted moving trajectory of the first virtual object 513 is displayed in the virtual scene, and the first attack prompt identifier 515 is displayed at the first end position of the first predicted moving trajectory.

In this embodiment of this disclosure, the distance condition is set, so that the reticle, the virtual object, and the attack prompt identifier corresponding to the virtual object are more intuitively displayed in the virtual scene, to better help the user shoot the position of the attack prompt identifier by using the shooting prop. In comparison with the related technology in which shooting can be performed by using the reticle, difficulty in shooting the virtual object can be reduced, so that the user can hit the virtual object without a long period of practice, thereby improving experience and fun of a shooting operation performed by the user.

In some embodiments, when “update a position of a reticle of the shooting prop based on the adjustment operation” in operation 102 is performed, display of the first predicted moving trajectory and the first attack prompt identifier is canceled in response to that the distance between the reticle and the first virtual object after the adjustment operation does not satisfy the distance condition.

In some embodiments, if the distance between the position of the reticle of the shooting prop that is updated based on the adjustment operation and the first virtual object is greater than or equal to the second distance threshold, it indicates that the updated position of the reticle of the shooting prop is far from the first virtual object. Therefore, the first predicted moving trajectory of the first virtual object and the first attack prompt identifier cannot be displayed in the virtual scene. If the distance between the position of the reticle of the shooting prop that is updated based on the adjustment operation and the first virtual object is less than the second distance threshold, but the distance between the first attack prompt identifier and the first virtual object is less than or equal to the third distance threshold, it indicates that the first virtual object blocks the first attack prompt identifier. Therefore, the first predicted moving trajectory of the first virtual object and the first attack prompt identifier also cannot be displayed in the virtual scene.

For example, FIG. 5B is a third schematic diagram of display of a virtual scene according to an embodiment of this disclosure. As shown in FIG. 5B, the virtual scene includes a shooting prop 521, a reticle 522 for aiming, a first virtual object 523, and a virtual object 524. When the second distance threshold is 100 pixels, because a distance s3 between the reticle 522 and the first virtual object 523 is 150 pixels, which is greater than the second distance threshold, a first predicted moving trajectory of the first virtual object 523 and a first attack prompt identifier cannot be displayed in the virtual scene. FIG. 5C is a fourth schematic diagram of display of a virtual scene according to an embodiment of this disclosure. As shown in FIG. 5C, the virtual scene includes a shooting prop 531, a reticle 532 for aiming, a first virtual object 533, and a virtual object 534. When the second distance threshold is 100 pixels, and the third distance threshold is a display radius of a circular surrounding of the first virtual object 533, although a distance s4 between the reticle 522 and the first virtual object 523 is 80 pixels, which is less than the second distance threshold, a distance between a first attack prompt identifier 535 and the first virtual object 523 in FIG. 5C is obviously less than the display radius of the circular surrounding of the first virtual object 533. In other words, the first virtual object 523 blocks the first attack prompt identifier 535. Therefore, a first predicted moving trajectory of the first virtual object 523 and the first attack prompt identifier 535 cannot be displayed in the virtual scene.

In this embodiment of this disclosure, when the position of the reticle of the shooting prop is updated based on the adjustment operation, in response to that the distance between the reticle and the first virtual object after the adjustment operation does not satisfy the distance condition, display of the first predicted moving trajectory and the first attack prompt identifier is canceled. In an actual operation process, if the trajectory and the prompt identifier continuously exist, when the user quickly switches a target or adjusts a visual angle, a plurality of overlapping trajectories may cause image chaos. In the foregoing solution of this disclosure, blanking is triggered based on the distance threshold, to help ensure that auxiliary information is displayed when the user actually focuses on a target (approached by the reticle), and is hidden in other cases. Trajectory prediction is activated when the distance between the reticle and the target is less than or equal to the threshold, and calculation is stopped when display is canceled, so that calculation costs can be reduced, and bandwidth occupation can be reduced.

In some embodiments, a degree of prominence indicated by a display parameter of the first attack prompt identifier in a first state is higher than a degree of prominence indicated by a display parameter of the first attack prompt identifier in a second state. The first state indicates that a distance between the reticle and the first attack prompt identifier is less than or equal to a first distance threshold, and the second state indicates that the distance between the reticle and the first attack prompt identifier is greater than the first distance threshold.

Herein, the first distance threshold may be manually set, or may be determined based on an optimum range of the shooting prop. For example, if the optimum range of the shooting prop is 200 meters, the first distance threshold may be 80% of the optimum range, that is, the first distance threshold may be 160 meters.

In some embodiments, the display parameter of the first attack prompt identifier may be a size of a shape of the first attack prompt identifier. A larger size indicates a higher degree of prominence. Alternatively, the display parameter may be a depth or brightness of a color of the first attack prompt identifier. A larger value of the depth or brightness of the color indicates a higher degree of prominence. Herein, that a degree of prominence indicated by a display parameter of the first attack prompt identifier in a first state is higher than a degree of prominence indicated by a display parameter of the first attack prompt identifier in a second state may be that a size of a shape of the first attack prompt identifier in the first state is greater than a size of a shape of the first attack prompt identifier in the second state. The shape of the first attack prompt identifier is not limited, and may be a rectangle, a circle, a triangle, a rhombus, a star, an arrow, a wave, or the like. For example, the shape of the first attack prompt identifier in the first state is a square whose side length is 100 pixels, and the shape of the first attack prompt identifier in the second state is a square whose side length is 50 pixels. Alternatively, a color depth at which the first attack prompt identifier is displayed in the first state may be deeper than a color depth at which the first attack prompt identifier is displayed in the second state.

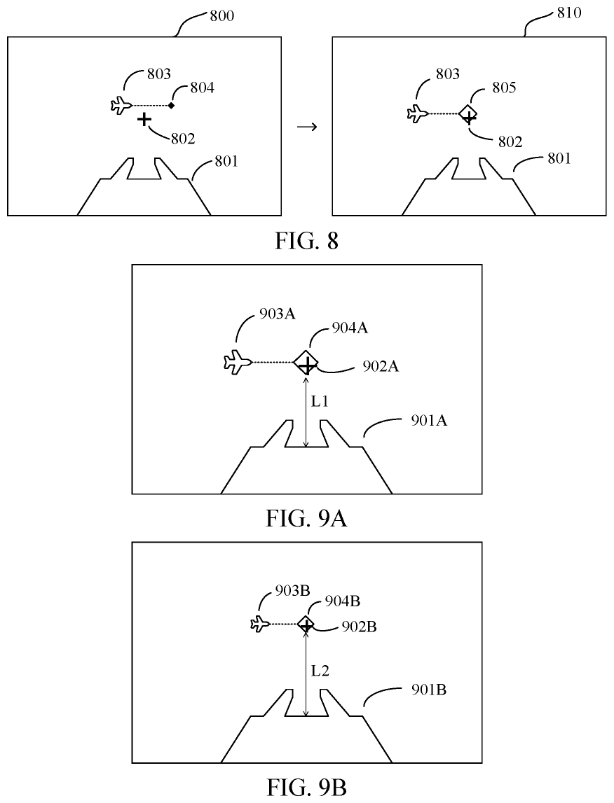

For example, as shown in FIG. 8, a shooting prop 801, an aiming point 802 for aiming, an object 803, and a virtual position identifier 804 are displayed on an interactive interface 800. In this case, a side length of the virtual position identifier 804 in a second state is 50 pixels. When the aiming point 802 for aiming is moved to a position of the virtual position identifier 804, the virtual position identifier 804 on the interactive interface 800 is converted into a virtual position identifier 805 shown on the interactive interface 810. In this case, a side length of the virtual position identifier 805 in a first state is 100 pixels, that is, a size of the virtual position identifier 805 is greater than a size of the virtual position identifier 804.

In this embodiment of this disclosure, display forms of the attack prompt identifier in the different states are distinguished, so that the user can learn an aiming situation in time, and adjust an aiming strategy based on the current situation. This helps the user more quickly aim at the virtual object by using the reticle, to determine a position of a to-be-shot object, thereby improving user experience.

In some embodiments, when the position of the reticle coincides with the first end position, in response to an attack trigger operation for the shooting prop, the first attack prompt identifier is converted into a hit effect when the shooting prop hits the first virtual object, or the first attack prompt identifier is converted into a destruction effect when the shooting prop destroys the first virtual object.

In some embodiments, when the position of the reticle coincides with the first end position, it indicates that the user has aimed at the first attack prompt identifier at the first end position by using the reticle of the shooting prop. In this case, when the attack trigger operation performed by the user on the first attack prompt identifier by using the shooting prop is detected, if it is detected that the shooting prop hits the first virtual object, the first attack prompt identifier is converted into the hit effect; or if it is detected that the shooting prop destroys the first virtual object, the first attack prompt identifier is converted into the destruction effect.

For example, in a shooting game scene, the hit effect may be flying sparks. To be specific, when a projectile (such as a bullet) of the shooting prop hits the virtual object (such as an airplane), a series of effects of flying sparks are generated, to simulate a moment at which the bullet hits the airplane. Alternatively, the hit effect may be a particle effect (for example, a fume effect or a fragment effect). The particle effect is used to simulate a complex hit effect when the virtual object is hit, for example, fume or fragments generated when the airplane is hit. The destruction effect may be an explosion animation. To be specific, when the virtual object (such as an airplane) is destroyed, the explosion animation is played, indicating a moment at which the airplane is destroyed. The explosion animation may be scattering fragments, to be specific, the destroyed airplane may generate a large quantity of fragments, and the fragments may scatter to a surrounding environment. Alternatively, the destruction effect may be fume and flames. To be specific, when the airplane is destroyed, a fume or flame effect is generated, thereby improving a visual impact.

Herein, whether the shooting prop hits or destroys the first virtual object may be determined according to a preset detection mechanism. The detection mechanism may include collision detection and shooting logic. Using a game scene as an example, when a player shoots an airplane (the virtual object) in the virtual scene by using the shooting prop, collision detection may be implemented by detecting whether a projectile shot from the shooting prop overlaps a boundary box of the airplane. If overlapping is detected, it indicates that the airplane is hit by using the shooting prop. If no overlapping is detected, it indicates that the airplane is not hit. When the shooting prop hits the airplane, according to preset shooting logic, a damage value to the airplane varies based on different shot positions. For example, damages caused when a vital part (such as an engine) of the airplane may be greater than those caused when a non-vital part (such as a wing) of the airplane. Therefore, the damage value to the airplane may be determined based on a shot point. When an accumulated damage value of a plurality of times of shooting is greater than or equal to a health value of the airplane, that is, the health value of the airplane is zero, it indicates that the airplane has been destroyed by using the shooting prop.

In this embodiment of this disclosure, the first attack prompt identifier in different cases is converted into the hit effect or the destruction effect, to construct a vision-behavior-result instant closed-loop feedback system. When the projectile hits or destroys the target, a form of the original prompt identifier is converted, for example instantly converted, into a special effect (such as sparks, an explosion, or fragments), and the user can determine a result without viewing a UI. The hit effect and the destruction effect are used to provide a visual feedback for the player, thereby adding a visual effect during shooting, and helping the user understand whether shooting of the user hits or destroys the target. In addition, these special effects also increase immersion and entertainment during shooting of the user.

In some embodiments, a size of the first attack prompt identifier is negatively correlated to a distance between the shooting prop and the first attack prompt identifier, and the size of the first attack prompt identifier is within a preset size range.

In some embodiments, the size of the first attack prompt identifier is maintained within the preset size range. Herein, that a size of the first attack prompt identifier is negatively correlated to a distance between the shooting prop and the first attack prompt identifier means that a larger distance between the shooting prop and the first attack prompt identifier indicates a smaller size of the first attack prompt identifier, and a smaller distance between the shooting prop and the first attack prompt identifier indicates a larger size of the first attack prompt identifier.

For example, the preset size range of the size of the first attack prompt identifier is from 30 pixels to 60 pixels. To be specific, a size range of space occupied by the first attack prompt identifier in the virtual scene is from 30 pixels to 60 pixels. The size of the first attack prompt identifier is indicated by using a geometrical parameter of the first attack prompt identifier. For example, when the first attack prompt identifier is a rectangle, the geometrical parameter of the size of the first attack prompt identifier is a length and a width of the rectangle. When the first attack prompt identifier is a circle, the geometrical parameter of the size of the first attack prompt identifier is a radius of the circle. When the distance between the shooting prop and the first attack prompt identifier is 200 meters, the size of the first attack prompt identifier is 50 pixels. When the distance between the shooting prop and the first attack prompt identifier is 1200 meters, the size of the first attack prompt identifier is 40 pixels. When the distance between the shooting prop and the first attack prompt identifier is 2400 meters, the size of the first attack prompt identifier is 30 pixels. In this case, the size of the first attack prompt identifier reaches the lower limit. When the distance between the shooting prop and the first attack prompt identifier is 3000 meters, the size of the first attack prompt identifier is still 30 pixels.

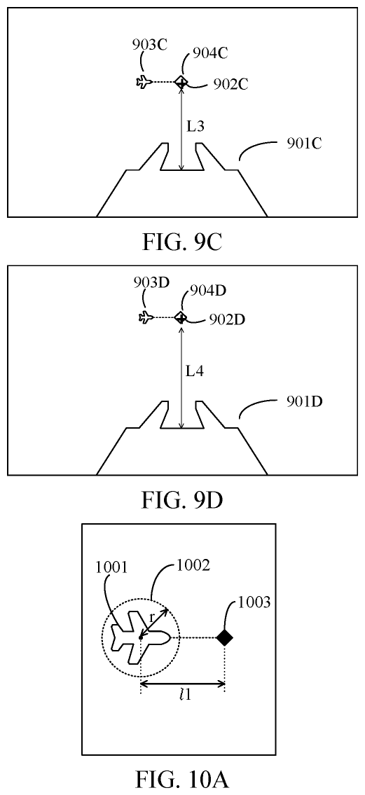

For example, FIG. 9A shows a shooting prop 901A, an aiming point 902A, an object 903A, and a virtual position identifier 904A. A distance L1 between the virtual position identifier 904A and the shooting prop 901A is 200 meters, and a size of the virtual position identifier 904A is 50 pixels. FIG. 9B is a fifth schematic diagram of interaction in a virtual scene according to an embodiment of this disclosure. FIG. 9B shows a shooting prop 901B, an aiming point 902B, an object 903B, and a virtual position identifier 904B. A distance L2 between the virtual position identifier 904B and the shooting prop 901B is 1200 meters, and a size of the virtual position identifier 904B is 40 pixels. FIG. 9C is a sixth schematic diagram of interaction in a virtual scene according to an embodiment of this disclosure. FIG. 9C shows a shooting prop 901C, an aiming point 902C, an object 903C, and a virtual position identifier 904C. A distance L3 between the virtual position identifier 904C and the shooting prop 901C is 2400 meters, and a size of the virtual position identifier 904C is 30 pixels. FIG. 9D is a seventh schematic diagram of interaction in a virtual scene according to an embodiment of this disclosure. FIG. 9D shows a shooting prop 901D, an aiming point 902D, an object 903D, and a virtual position identifier 904D. A distance L4 between the virtual position identifier 904D and the shooting prop 901D is 3000 meters, and a size of the virtual position identifier 904D is still 30 pixels.

In the foregoing solution of this embodiment of this disclosure, the size of the first attack prompt identifier is negatively correlated to the distance between the shooting prop and the first attack prompt identifier, and the size of the first attack prompt identifier is within the preset size range. In comparison with the related technology in which a shooting game relies on a health bar, a number, or an additional UI to display an enemy distance, and a user needs to switch attention back and forth between aiming and reading the UI, a perspective law of near-large and far-small is directly mapped to the size of the prompt identifier, and the user can observe the size of the prompt identifier to determine the target distance, thereby improving user experience.

In some embodiments, FIG. 3C is a first schematic flowchart of determining a first end position according to an embodiment of this disclosure. Before the “display a first attack prompt identifier at a first end position of the first predicted moving trajectory” in operation 103 is performed, the first end position may be determined by performing operation 201 and operation 202 in FIG. 3C.

Operation 201: Obtain a first constraint condition, the first constraint condition including that a difference between a first time taken by the first virtual object to move from a current position to a target position and a second time taken by the projectile of the shooting prop to fly to the target position is less than a time threshold, the first time being determined based on the current moving state of the first virtual object, and the second time being determined based on a distance between the shooting prop and the first virtual object, and a flight direction and a flight velocity of the projectile of the shooting prop.

In some embodiments, the first time taken by the first virtual object to move from the current position to the target position can be determined based on the current moving state of the first virtual object, and the second time taken by the projectile of the shooting prop to fly from the current position to the target position can be determined based on the distance between the shooting prop and the first virtual object, and the flight direction and the flight velocity of the projectile of the shooting prop. When the difference between the first time taken by the first virtual object to move from the current position to the target position and the second time taken by the projectile of the shooting prop to fly to the target position is less than the time threshold, it indicates that the projectile of the shooting prop can hit the first virtual object at the target position when the first virtual object moves in the current moving state and the projectile of the shooting prop flies according to the current flight direction and flight velocity.

Herein, the current moving state of the first virtual object includes a current moving direction and moving velocity of the first virtual object. The moving direction is represented by a vector of a three-dimensional coordinate system (for example, an X axis represents a horizontal direction, a Y axis represents a vertical direction, and a Z axis represents a depth direction). For example, an enemy fighting vehicle moves toward “30 degrees north of northeast”, and a direction vector in the corresponding coordinate system is (cos 30°, 0, sin 30°), where a positive direction of the X axis is east, and a positive direction of the Z axis is north. The moving velocity refers to a displacement (a speed) within a unit time, and the moving velocity is measured in “meters/second (m/s)”. For example, a velocity of a rapidly moving unmanned aerial vehicle is 20 m/s, and a velocity of a slowly walking character is 1.5 m/s.

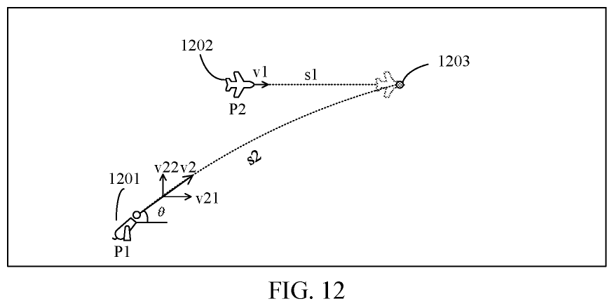

For example, referring to FIG. 12, FIG. 12 shows a shooting prop 1201, an object 1202, and a virtual position identifier 1203. A shooting angle of the shooting prop 1201 is 0. An initial position of the shooting prop 1201 is P1, where an initial position of a projectile of the shooting prop 1201 may be considered as P1. An initial position of the object 1202 is P2. If coordinates of P1 are (x1, y1), and coordinates of P2 are (x2, y2), a coordinate difference s0 between the projectile of the shooting prop 1201 and the object 1202 in a horizontal direction may be represented as x1-x2. Assuming that a current moving velocity of the object 1202 is v1 based on a current moving direction and the moving velocity of the object 1202, a first time t1 taken by the object 1202 to move from a current position to a target position of the virtual position identifier 1203 may be represented as s1/v1. Assuming that a current flight velocity of the projectile of the shooting prop 1201 is v2 based on a current flight direction and the flight velocity of the projectile of the shooting prop 1201, a velocity of the projectile in the horizontal direction may be represented as v21=v2*cos θ, and a velocity of the projectile in a vertical direction may be represented as v22=v2*sin θ. In this case, a second time t2 taken by the projectile of the shooting prop to fly from the current position to the target position may be represented as s2*cos θ/v22. In this case, s2*cos θ=s0+s1. A difference between the first time taken by the first virtual object to fly from the current position to the target position and the second time taken by the projectile of the shooting prop to fly to the target position is less than a time threshold, that is, a difference between the first time t1 and the second time t2 is less than the time threshold.

Operation 202: Determine the target position satisfying the first constraint condition as the first end position.

For example, when the difference between the first time t1 taken by the first virtual object to fly from the current position to the target position and the second time t2 taken by the projectile of the shooting prop to fly to the target position is 0, s1/v1=s2*cos θ/v22, and s2*cos θ=s0+s1. After resolving, a value of s1 may be obtained. When it is learned that coordinates of an initial position P2 of the object 1202 are (x2, y2), it may be learned that coordinates of the target position are (x2+s1, y2).

In some embodiments, when there are a plurality of target positions satisfying the first constraint condition, it indicates that a first virtual object at any one of the target positions can be hit when the target position is shot by using the shooting prop. In this case, any one of the plurality of target positions may be selected as the first end position. Alternatively, the target position closest to the shooting prop is selected as the first end position.

In some embodiments, FIG. 3D is a second schematic flowchart of determining a first end position according to an embodiment of this disclosure. Before the “display a first attack prompt identifier at a first end position of the first predicted moving trajectory” in operation 103 is performed, the first end position may be determined by performing operation 301 and operation 302 in FIG. 3D.

Operation 301: Obtain a second constraint condition, the second constraint condition including that a first time taken by the first virtual object to move from a current position to a target position is equal to a sum of second time and a third time, the second time being a time interval from display of the first attack prompt identifier to shooting of the shooting prop, and the third time being a time taken by the projectile of the shooting prop to fly to the target position.

In some embodiments, in consideration of a time interval from display of the first attack prompt identifier in the virtual scene to shooting performed by using the shooting prop, that is, when there is a shooting delay during shooting, the first time taken by the first virtual object to move from the current position to the target position can be determined based on a current moving state (a moving direction and a moving velocity) of the first virtual object, and the third time taken by the projectile of the shooting prop to fly from the current position to the target position can be determined based on a distance between the shooting prop and the first virtual object, and a flight direction and a flight velocity of the projectile of the shooting prop. Assuming that the time interval from display of the first attack prompt identifier to shooting performed by using the shooting prop is the second time, when the first time taken by the first virtual object to move from the current position to the target position is equal to the sum of the second time and the third time, it indicates that the projectile of the shooting prop can hit the first virtual object at the target position when the first virtual object moves in the current moving state and the projectile of the shooting prop flies according to the current flight direction and flight velocity.

For example, still referring to FIG. 12, FIG. 12 shows the shooting prop 1201, the object 1202, and the virtual position identifier 1203. The shooting angle of the shooting prop 1201 is θ. The initial position of the shooting prop 1201 is P1, where the initial position of the projectile of the shooting prop 1201 may be considered as P1. The initial position of the object 1202 is P2. If the coordinates of P1 are (x1, y1), and the coordinates of P2 are (x2, y2), the coordinate difference s0 between the projectile of the shooting prop 1201 and the object 1202 in the horizontal direction may be represented as x1-x2. Assuming that the current moving velocity of the object 1202 is v1 based on the current moving direction and the moving velocity of the object 1202, the first time t1 taken by the object 1202 to move from the current position to the target position of the virtual position identifier 1203 may be represented as s1/v1. It is assumed that a time interval from display of the virtual position identifier 1203 to shooting performed by using the shooting prop 1201 is t3. Assuming that the current flight velocity of the projectile of the shooting prop 1201 is v2 based on the current flight direction and the flight velocity of the projectile of the shooting prop 1201, the velocity of the projectile in the horizontal direction may be represented as v21=v2*cos θ, and a velocity of the projectile in a vertical direction may be represented as v22=v2*sin θ. In this case, a third time t2 taken by the projectile of the shooting prop to fly from the current position to the target position may be represented as s2*cos θ/v22. In this case, s2*cos θ=s0+s1. the first time taken by the first virtual object to move from the current position to the target position is equal to a sum of the second time and the third time, that is, t1=t2+t3.

Operation 302: Determine the target position satisfying the second constraint condition as the first end position.

For example, when the first time taken by the first virtual object to move from the current position to the target position is equal to the sum of the second time and the third time, s1/v1=s2*cos θ/v22+t3, and s2*cos θ=s0+s1. After resolving, a value of s1 may be obtained. When it is learned that coordinates of an initial position P2 of the object 1202 are (x2, y2), it may be learned that coordinates of the target position are (x2+s1, y2).

In this embodiment of this disclosure, in combination of the flight direction and the flight velocity of the projectile of the shooting prop and the moving direction and the moving velocity of the virtual object, a delay problem that may exist in an implementation process of shooting the virtual object is fully considered, and a time length of the delay is used as a factor of the constraint condition to determine the target position, so that the target position can be more accurately determined, thereby improving a possibility of hitting the virtual object by using the shooting prop.

In some embodiments, when there are a plurality of target positions satisfying the second constraint condition, either of the following processing may be performed: selecting any one of the plurality of target positions as the first end position; or selecting one of the plurality of target positions as the first end position based on a second preset condition, the second preset condition including selecting the target position closest to the shooting prop.

In some embodiments, when there are a plurality of target positions satisfying the second constraint condition, it indicates that a first virtual object at any one of the target positions can be hit when the target position is shot by using the shooting prop.

For example, the target positions satisfying the second constraint condition include a position 1, a position 2, and a position 3, where a distance between the position 1 and the shooting prop is 100 meters, a distance between the position 2 and the shooting prop is 200 meters, and a distance between the position 3 and the shooting prop is 300 meters. Any one of the three target positions may be used as the first end position. For example, the position 2 may be used as the first end position. Alternatively, one of the plurality of target positions may be selected as the first end position based on a second preset condition. When the second preset condition is selecting a target position closest to the shooting prop, the position 1 may be used as the first end position.

In some embodiments, in response to an attack trigger operation for the shooting prop when the shooting prop does not hit the first virtual object and the first virtual object follows an evasion route after the shooting prop attacks, a second predicted moving trajectory of the first virtual object is displayed if a distance between the position of the reticle and the first virtual object in the evasion route satisfies the distance condition; and a second attack prompt identifier is displayed at a second end position of the second predicted moving trajectory, the second end position being a position that the first virtual object is to reach when moving according to the second predicted moving trajectory, and the second attack prompt identifier being configured for prompting to attack the second end position by using the shooting prop.

In some embodiments, when the attack trigger operation for the shooting prop is detected, if it is detected that the shooting prop does not hit the first virtual object, the first virtual object may follow the evasion route after the shooting prop attacks. When the distance between the position of the reticle and the first virtual object in the evasion route satisfies the distance condition, the second predicted moving trajectory of the first virtual object may be displayed in the virtual scene, and the second attack prompt identifier is displayed at the second end position of the second predicted moving trajectory. When the virtual object moves according to the second predicted moving trajectory, the second attack prompt identifier at the second end position may be shot by using the shooting prop, that is, the first virtual object may be hit.

Herein, the distance condition refers to a spatial distance between the position of the reticle in the virtual scene and a real-time position of the first virtual object in the evasion route, and is less than a preset trigger threshold. For example, in a three-dimensional shooting game, if the trigger threshold is 5 meters, it is determined that the distance condition is satisfied when a distance between a reticle ray and an evading virtual object is less than 5 meters. The distance between the position of the reticle and the first virtual object in the evasion route may be determined in the following manner: In a two-dimensional scene, an Euclidean distance between pixel coordinates (x₁, y₁) of the reticle and center pixel coordinates (x₂, y₂) of the virtual object is \sqrt{(x₁−x₂)²+(y₁−y₂)²}. In a three-dimensional scene, the distance between the position of the reticle and the first virtual object in the evasion route is a smallest spatial distance between a ray corresponding to the reticle and a collision body of the virtual object.

For example, FIG. 5D is a fifth schematic diagram of display of a virtual scene according to an embodiment of this disclosure. As shown in FIG. 5D, an interactive interface 510 includes a shooting prop 541, a reticle 542 for aiming, a first virtual object 543, a virtual object 544, and a first attack prompt identifier 545 corresponding to the first virtual object 543. When the first virtual object 543 moves in a current moving state, when the first virtual object 543 moves to a position on the interactive interface 520, the first attack prompt identifier 545 is shot by using the shooting prop 541. If the shooting prop 541 does not hit the first virtual object 543, the first virtual object 543 starts to follow an evasion route. Because a distance between the reticle 542 on the interactive interface 520 and the first virtual object 543 in the evasion route satisfies a distance condition, a second predicted moving trajectory of the first virtual object 543 is displayed on the interactive interface 520, and a second attack prompt identifier 546 is displayed at a second end position of the second predicted moving trajectory.

In this embodiment of this disclosure, a possibility that the shot virtual object follows the evasion route in a shot process is considered, so that a policy can be adjusted in time based on the evasion route of the virtual object. The predicted moving trajectory of the virtual object when the virtual object moves along the evasion route is displayed, and the corresponding attack prompt identifier is displayed at the end position of the predicted moving trajectory, so that it can be ensured that the virtual object can still be hit when the virtual object has an evasion skill, thereby improving hit accuracy.

In some embodiments, when the at least one virtual object in the virtual scene includes a plurality of virtual objects, FIG. 3E is a second schematic flowchart of an interaction processing method for a virtual scene according to an embodiment of this disclosure. An interaction process in the virtual scene is implemented by performing operation 401 and operation 402 in FIG. 3E. Details are described below.

Operation 401: In response to that a distance between the position of the reticle and each of the plurality of virtual objects satisfies the distance condition, display a plurality of third predicted moving trajectories respectively corresponding to at least one second virtual object, and display a corresponding third attack prompt identifier at a third end position of each of the third predicted moving trajectories, the plurality of virtual objects including the first virtual object and the at least one second virtual object.

In some embodiments, when the at least one virtual object in the virtual scene includes the plurality of virtual objects, and the plurality of virtual objects include the first virtual object and the at least one second virtual object, if the distance between the position of the reticle and each of the plurality of virtual objects satisfies the distance condition, in addition to the first predicted moving trajectory corresponding to the first virtual object and the first attack prompt identifier displayed at the first end position of the first predicted moving trajectory, the third predicted moving trajectory corresponding to the second virtual object may further be displayed on the interactive interface of the virtual scene, and the third attack prompt identifier is displayed at the third end position of the third predicted moving trajectory.

Herein, real-time distances between the position of the reticle and the virtual objects may be simultaneously determined through multi-thread or distributed calculation. For example, a distance between the reticle and a virtual object 1 is calculated by using a thread 1, a distance between the reticle and a virtual object 2 is calculated by using a thread 2, and a distance between the reticle and a virtual object 3 is calculated by using a thread 3. Then, for each of the virtual objects, whether the distance between the position of the reticle and the virtual object satisfies the distance condition is determined. If yes, the virtual object is marked as a to-be-displayed object. After determining of the distance is completed, the virtual object marked as the to-be-displayed object is rendered, and the predicted moving trajectory corresponding to the virtual object is displayed.

For example, FIG. 5E is a sixth schematic diagram of display of a virtual scene according to an embodiment of this disclosure. As shown in FIG. 5E, the virtual scene includes a shooting prop 551, a reticle 552 for aiming, a first virtual object 553, a second virtual object 554, a third virtual object 555, a first predicted moving trajectory corresponding to the first virtual object 553, where a first attack prompt identifier 556 is displayed at a first end position of the first predicted moving trajectory, a third predicted moving trajectory corresponding to the second virtual object 554, where a third attack prompt identifier 557 is displayed at a third end position of the third predicted moving trajectory, and a third predicted moving trajectory corresponding to the third virtual object 555, where a third attack prompt identifier 558 is displayed at a third end position of the third predicted moving trajectory.

Operation 402: Select a target attack prompt identifier from the plurality of third attack prompt identifiers, the target attack prompt identifier being configured for prompting to attack a third end position corresponding to the target attack prompt identifier by using the shooting prop.

Herein, in the manner of selecting the target attack prompt identifier from the plurality of third attack prompt identifiers, quick switching or direct selection may be implemented by using a physical key of a device such as a keyboard or a gamepad, to adapt to a scenario requiring blind operation or a quick response. For example, a unique number key (for example, 1, 2, or 3) or a functional key (for example, F1 or F2) is allocated to each third attack prompt identifier, and the target may be selected in response to that the user presses the corresponding key. Alternatively, in the manner of selecting the target attack prompt identifier from the plurality of third attack prompt identifiers, an identifier position may be directly clicked or touched by using a device such as a mouse or a touchscreen, to adapt to a scenario requiring precise clicking and selection. This manner is intuitive and conforms to operation intuition of the user on a graphical interface. For example, in response to that the user moves a mouse to a position of a target identifier, the user may select the target identifier by clicking a left button. After the target identifier is selected, a dynamic feedback (for example, bounce and glow) occurs. For example, a rhombus is immediately enlarged to 1.2 times of an original size, and a crosshair appears in a center, to prompt “A target has been selected”.

In some embodiments, the plurality of third attack prompt identifiers all indicate that the corresponding second virtual objects can be hit when the third end positions corresponding to the third attack prompt identifiers are shot by using the shooting prop, so that the target attack prompt identifier may be selected from the plurality of third attack prompt identifiers based on a user requirement, to shot the corresponding second virtual object.

In some embodiments, “select a target attack prompt identifier from the plurality of third attack prompt identifiers” in operation 402 may be implemented by performing any one of the following processing: selecting any one of the plurality of third attack prompt identifiers as the target attack prompt identifier; or selecting the target attack prompt identifier from the plurality of third attack prompt identifiers based on a third preset condition, where the third preset condition may be selecting the third attack prompt identifier closest to the shooting prop.

For example, still referring to FIG. 5E, if a distance between the third attack prompt identifier 557 and the shooting prop 551 is 1200 meters, and a distance between the third attack prompt identifier 558 and the shooting prop 551 is 1000 meters, the third attack prompt identifier 557 or the third attack prompt identifier 558 may be selected as the target attack prompt identifier. Alternatively, the third attack prompt identifier 558 that is closer to the shooting prop 551 may be used as the target attack prompt identifier based on the third preset condition.

In some embodiments, “select a target attack prompt identifier from the plurality of third attack prompt identifiers” in operation 402 may include: determining, in response to a selection operation on one of the plurality of third attack prompt identifiers, the selected third attack prompt identifier as the target attack prompt identifier.

For example, still referring to FIG. 5E, if the distance between the third attack prompt identifier 557 and the shooting prop 551 is 1200 meters, and the distance between the third attack prompt identifier 558 and the shooting prop 551 is 1000 meters, the third attack prompt identifier 557 or the third attack prompt identifier 558 may be selected as the target attack prompt identifier.

In some embodiments, “select a target attack prompt identifier from the plurality of third attack prompt identifiers” in operation 402 may include: selecting one of the plurality of third attack prompt identifiers as the target attack prompt identifier based on a first preset condition, the first preset condition including selecting the third attack prompt identifier closest to the shooting prop.

For example, still referring to FIG. 5E, if the distance between the third attack prompt identifier 557 and the shooting prop 551 is 1200 meters, and the distance between the third attack prompt identifier 558 and the shooting prop 551 is 1000 meters, the third attack prompt identifier 558 that is closer to the shooting prop 551 may be used as the target attack prompt identifier based on the first preset condition.

In this embodiment of this disclosure, when the plurality of virtual objects exist in the virtual scene, the user can select a to-be-shot object based on the requirement, so that fun of shooting the virtual object by the user by using the shooting prop can be improved, and user experience is improved.

In some embodiments, FIG. 3F is a schematic flowchart of obtaining a target attack prompt identifier according to an embodiment of this disclosure. “Select a target attack prompt identifier from the plurality of third attack prompt identifiers” in operation 402 may be implemented by performing operation 4021 to operation 4023 in FIG. 3F. Details are described below.

Operation 4021: Obtain defense feature information of the second virtual object and attack feature information of the shooting prop.

In some embodiments, the target attack prompt identifier may be selected from the plurality of third attack prompt identifiers by using an artificial intelligence technology. Before the attack prompt identifier is selected, the defense feature information of the second virtual object and the attack feature information of the shooting prop need to be obtained. Herein, the defense feature information of the second virtual object may refer to a defense attribute and capability of the second virtual object, for example, an armor level, an evasion capability, and a defense skill of the virtual object. The attack feature information of the shooting prop may refer to a type of the shooting prop and a type of the projectile. For example, types of projectiles respectively corresponding to a virtual firearm and a virtual tank are a bullet and a shell. It is clear that power of the shell is much greater than power of the bullet.

Operation 4022: Invoke a pre-trained machine learning model based on the defense feature information of the second virtual object and the attack feature information of the shooting prop, to obtain a hit probability of attacking the second virtual object by using the shooting prop.

In some embodiments, the pre-trained machine learning model may be obtained by performing the following processing: first obtaining a training data set, the training data set including a plurality of groups of defense feature information samples of virtual object samples and attack feature samples of shooting prop samples, and label information (where 1 indicates hitting, and 0 indicates missing) indicating whether the shooting prop samples hit the corresponding virtual object samples; then invoking an initialized machine learning model in which the plurality of groups of the defense feature information samples of the virtual object samples and the attack feature samples of the shooting prop samples are used as an input, to predict predicted probabilities of the shooting prop samples in the training samples hitting the corresponding virtual object samples, using the predicted probabilities as an output result, and comparing the output result with the label information; determining a loss value by using a loss function based on differences between the predicted probabilities and the label information; and updating a parameter of the initialized machine learning model by using a backpropagation algorithm based on the loss value.

Herein, a structure of the machine learning model may include an input layer, a hidden layer, and an output layer. In a forward propagation process, the plurality of groups of the defense feature information samples of the virtual object samples and the attack feature samples of the shooting prop samples are used as the input, linear processing is performed on the defense feature information samples and the attack feature samples through the hidden layer, to obtain linear features, the linear features are activated by using an activation function, to obtain output features of the hidden layer, and finally, normalization processing is performed on the output features of the hidden layer through the output layer, to obtain the predicted probabilities of hitting the corresponding virtual object samples by using the shooting prop samples in the training samples.

For example, the defense feature information sample of the virtual object sample is “velocity=3 m/s (horizontal movement), an angle between a direction and a shooting line is 30°, and a volume is 0.8 m*0.5 m”, and the attack feature sample of the shooting prop sample is “muzzle velocity=300 m/s, a ballistic diffusion angle is 1°, a reticle deviation is 2°, and a shooting distance is 20 m”. First, embedding processing is performed on the defense feature information sample of the virtual object sample and the attack feature sample of the shooting prop sample, to obtain an input vector X. Then, linear processing is performed on the input vector through the hidden layer. For example, a weight matrix W1 (4*8) of the hidden layer is initialized as follows:

$$W 1 = [ \begin{matrix}0.1 & 0.2 & 0.3 & 0.4 & 0.5 & 0.6 & 0.7 & 0.8 \\ 0.2 & 0.3 & 0.4 & 0.5 & 0.6 & 0.7 & 0.8 & 0.9 \\ 0.3 & 0.4 & 0.5 & 0.6 & 0.7 & 0.8 & 0.9 & 0.1 \\ 0.4 & 0.5 & 0.6 & 0.7 & 0.8 & 0.9 & 0.1 & 0.2\end{matrix} ]$$

A bias b1 of the hidden layer is initialized as [0.1, 0.2, 0.3, 0.4]. In this case, a linear feature Z1 is W1*X+b1=[1.86, 2.14, 2.04, 1.96]. Activation processing is performed on the linear feature Z1, and an obtained output feature A1 of the hidden layer is [1.86, 2.14, 2.04, 1.96].

If a weight W2 of the output layer is [0.5, 0.3, 0.2, 0.1], and b2=0.1, linear calculation is performed on the output feature A1 of the hidden layer, and an obtained linear feature Z2 of the output layer is W2*A1+b2=2.234. Finally, normalization processing is performed on the linear feature Z2 of the output layer by using a sigmoid function, and an obtained predicted probability p is 0.9.

In a backpropagation process, the loss value may be transferred from the output layer to the input layer by using the backpropagation algorithm, so that the machine learning model can learn a difference between the predicted probability and the label information, and a gradient of each parameter in the machine learning model is calculated based on the loss value. The parameter of the initial machine learning model is updated based on the gradient of the parameter and a preset learning rate by using an optimization algorithm, to reduce the loss value. A plurality of rounds of iterative training are performed on the machine learning model until the loss value of the machine learning model converges or a preset quantity of training rounds is reached.

For example, the machine learning model may be a multilayer perceptron (MLP), a convolutional neural network (CNN), a recurrent neural network (RNN), a variational autoencoder (VAE), a transformer, a long short-term memory (LSTM), or proximal policy optimization (PPO). The loss function for determining the loss value may be a mean squared error (MSE), a root mean squared error (RMSE), a mean absolute error (MAE), a cross-entropy loss (Cross-Entropy Loss), or the like.

Operation 4023: Determine the third attack prompt identifier corresponding to the second virtual object having a largest hit probability as the target attack prompt identifier.

For example, the second virtual objects displayed in the virtual scene are respectively a virtual object 1, a virtual object 2, and a virtual object 3. The virtual object 1 corresponds to an attack prompt identifier 1, the virtual object 2 corresponds to an attack prompt identifier 2, and the virtual object 3 corresponds to an attack prompt identifier 3. If a probability of hitting the virtual object 1 by using the shooting prop is 0.5, a probability of hitting the virtual object 2 by using the shooting prop is 0.8, and a probability of hitting the virtual object 3 by using the shooting prop is 1, the attack prompt identifier 3 corresponding to the virtual object 3 is used as the target attack prompt identifier.

In this embodiment of this disclosure, the pre-trained machine learning model is invoked, the probability of hitting the virtual object by using the shooting prop is predicted with reference to the defense feature information of the to-be-shot object and the attack feature information of the shooting prop, and the target attack prompt identifier is determined from the plurality of attack prompt identifiers based on the probability that the virtual object is hit when each attack prompt identifier is shot by using the shooting prop. A large amount of data support in a training process of the machine learning model can be used, to provide a more accurate shooting position for the user, so that a probability that the user hits the virtual object is greater, thereby improving the probability that the user hits the virtual object.

In some embodiments, FIG. 3G is a third schematic flowchart of an interaction processing method for a virtual scene according to an embodiment of this disclosure. When “display a first predicted moving trajectory of a first virtual object” in operation 103 is performed, operation 501 and operation 502 in FIG. 3G may further be performed. Details are described below.

Operation 501: Display at least one fourth predicted moving trajectory of the first virtual object, and display a fourth attack prompt identifier at a fourth end position of each of the at least one fourth predicted moving trajectory.

In some embodiments, when the first virtual object corresponds to a plurality of predicted moving trajectories, the plurality of predicted moving trajectories may be simultaneously displayed, and a corresponding attack prompt identifier is displayed at an end position of each of the predicted moving trajectories. For example, the first predicted moving trajectory may be displayed on the interaction interface of the virtual scene, the first attack prompt identifier is displayed at the first end position of the first predicted moving trajectory, the at least one fourth predicted moving trajectory of the first virtual object is simultaneously displayed, and the fourth attack prompt identifier is displayed at the fourth end position of each of the at least one fourth predicted moving trajectory.

For example, FIG. 5F is a seventh schematic diagram of display of a virtual scene according to an embodiment of this disclosure. As shown in FIG. 5F, the virtual scene includes a shooting prop 561, a reticle 562 for aiming, a first virtual object 563, and a first predicted moving trajectory r1 corresponding to the first virtual object 563, where a first attack prompt identifier 564 is displayed at a first end position of the first predicted moving trajectory r1, a fourth predicted moving trajectory r2 corresponding to the first virtual object 563, where a fourth attack prompt identifier 565 is displayed at a fourth end position of the fourth predicted moving trajectory r2, and a fourth predicted moving trajectory r3 corresponding to the first virtual object 563, where a fourth attack prompt identifier 566 is displayed at a fourth end position of the fourth predicted moving trajectory r3.

Operation 502: Determine, in response to a selection operation on any one of the first attack prompt identifier and the fourth attack prompt identifier, the selected attack prompt identifier as a target attack prompt identifier, the target attack prompt identifier being configured for prompting to attack the fourth end position by using the shooting prop.

In some embodiments, “a selection operation on any one of the first attack prompt identifier and the fourth attack prompt identifier” in operation 502 may be implemented by performing any one of the following processing: selecting any one of the first attack prompt identifier and the fourth attack prompt identifier as the target attack prompt identifier; or selecting the target attack prompt identifier from the plurality of attack prompt identifiers based on a third preset condition, where the third preset condition may be selecting the attack prompt identifier closest to the shooting prop.

Herein, in the manner of selecting any one of the first attack prompt identifier and the fourth attack prompt identifier, quick switching or direct selection may be implemented by using a physical key of a device such as a keyboard or a gamepad, to adapt to a scenario requiring blind operation or a quick response. For example, a unique number key (for example, 1, 2, or 3) or a functional key (for example, F1 or F2) is allocated to each third attack prompt identifier, and the corresponding attack prompt identifier may be selected in response to that the user presses the corresponding key. Alternatively, an identifier position may be directly clicked or touched by using a device such as a mouse or a touchscreen, to adapt to a scenario requiring precise clicking and selection. This manner is intuitive and conforms to operation intuition of the user on a graphical interface. For example, in response to that the user moves a mouse to a position of a target identifier, the user may select a corresponding attack prompt identifier by clicking a left button. After the attack prompt identifier is selected, a dynamic feedback (for example, bounce and glow) occurs. For example, a rhombus is immediately enlarged to 1.2 times of an original size, and a crosshair appears in a center, to prompt “A target has been selected”.

For example, still referring to FIG. 5F, if a distance between the first attack prompt identifier 564 and the shooting prop 561 is 1000 meters, a distance between the fourth attack prompt identifier 565 and the shooting prop 551 is 1200 meters, and a distance between the fourth attack prompt identifier 566 and the shooting prop 551 is 1400 meters, any one of the first attack prompt identifier 564, the fourth attack prompt identifier 565, or the fourth attack prompt identifier 566 may be selected as the target attack prompt identifier. Alternatively, the first attack prompt identifier 564 that is closer to the shooting prop 551 may be used as the target attack prompt identifier based on the third preset condition.

In this embodiment of this disclosure, the shooting direction of the shooting prop in the virtual scene is adjusted to dynamically adjust the position of the reticle, and the shooting direction and the position of the reticle are linked in real time, to address a problem of an aiming delay caused by “direction-reticle separation” in a shooting game in a related technology. A user can automatically synchronize the direction with the reticle without manually calibrating an offset of the reticle, so that operation complexity can be reduced. When a distance between the reticle and a virtual object satisfies the distance condition, a predicted moving trajectory of the virtual object is displayed. Trajectory prediction is triggered based on the distance condition, to implement intelligent aiming assistance, so that the user does not need to estimate a target moving path, and the trajectory is automatically calculated and displayed. In addition, an attack prompt identifier is displayed at an end position of the predicted moving trajectory, so that the predicted moving trajectory of the virtual object and the attack prompt identifier are more intuitively displayed. Depending on an auxiliary effect of the attack prompt identifier, the user can more clearly determine a to-be-shot target position when aiming by using the reticle of the shooting prop. In comparison with the related technology in which aiming is performed by using the reticle of the shooting prop, a user with less shooting experience can more easily hit an interaction efficiency, reducing occupation of resources of an electronic device, and improving user experience.

The following describes example application of this embodiment of this disclosure in an actual application scenario.

Using a game scene as an example, in a battlefield game, when a player shoots a distant object moving at a high velocity, it is very difficult to hit a target. For example, when the player uses an anti-aircraft warfare (namely, a shooting prop) to shoot a fighter aircraft (namely, a virtual object) in flight, because a distance between the fighter aircraft and the anti-aircraft warfare is long, on one hand, a shell has a flight time delay, and a falling trajectory of the shell is a parabola, and on the other hand, a velocity of the fighter is fast. Therefore, when the player aims at the fighter aircraft by using an aiming point (namely, a reticle) fixed at a center of a screen, the player needs to predict flight trajectories and times of the aircraft and the shell, to hit the fighter aircraft. In this case, it is very difficult for the shell to hit the fighter aircraft in flight, and the player needs to perform a long period of practice to gradually improve a hit rate.

In the interaction processing method for a virtual scene provided in this embodiment of this disclosure, a virtual position is determined, with reference to a flight velocity and a parabolic trajectory of a bullet, based on a moving direction and velocity of a target object and a distance between the target object and a shooting prop. When the target object maintains moving in a current state, a player can hit the target object by shooting a virtual position identifier (an attack prompt identifier) at the virtual position, so that the player can hit an object moving at a high velocity. Display and hiding of the virtual position identifier is controlled based on whether an aiming point of the player enters a display region of the target object and the virtual position identifier and whether the virtual position identifier blocks the target object. A size of the virtual position identifier is also controlled based on a distance between the target object and the player, and state switching of the virtual position identifier is controlled based on an interaction state between the player and the target object.

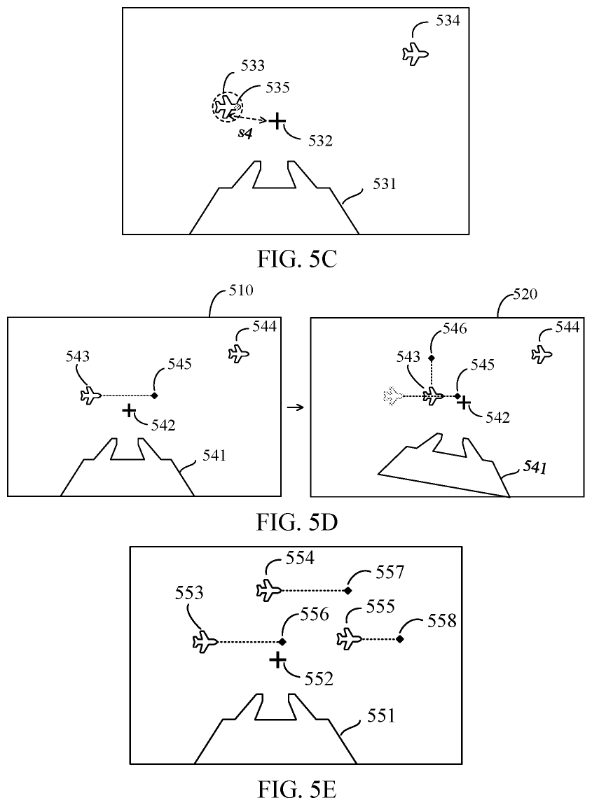

FIG. 6 is a first schematic diagram of interaction in a virtual scene according to an embodiment of this disclosure. As shown in FIG. 6, a shooting prop 601, an aiming point 602 for aiming, an object 603, and an object 604 are displayed on an interactive interface 600. The object 603 and the object 604 move at a high velocity on the interactive interface 600. When the aiming point 602 used by a player for aiming moves toward the object 603 until the aiming point 602 moves to a gray region 605 on the interactive interface 610, a virtual position identifier 606 is displayed on the interactive interface 610. The object 603 and the virtual position identifier 606 are connected by using a dashed line, which represents a moving trajectory of the object 603. Only when the aiming point 602 moves to a range of the gray region 605 in which the object 603 and the virtual position identifier 606 are located, the virtual position identifier 606 and the dashed line are displayed on the interactive interface 610, thereby avoiding overload of image information displayed on the interactive interface that is caused due to excessive objects moving at a high velocity and displayed on the same interactive interface.

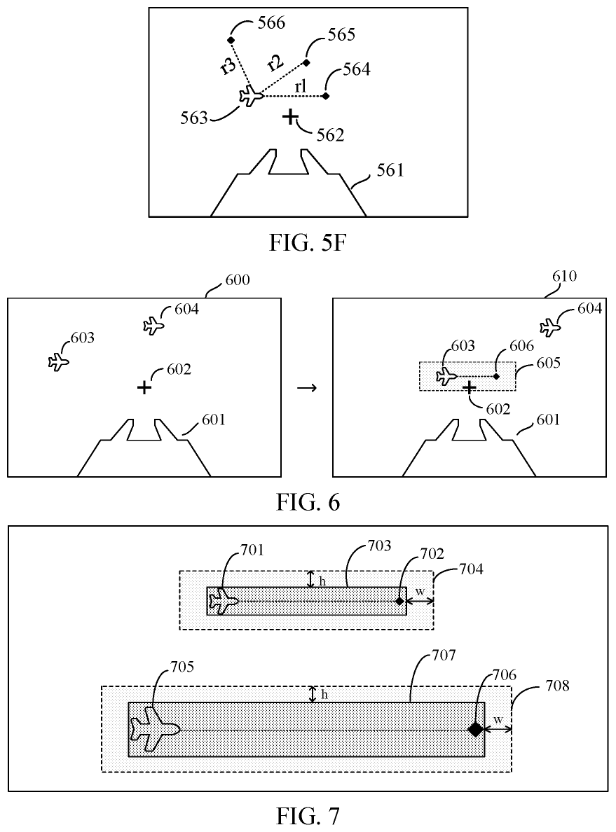

A size of the gray region is determined based on real-time positions of the object moving at the high velocity and the virtual position identifier. FIG. 7 is a second schematic diagram of interaction in a virtual scene according to an embodiment of this disclosure. As shown in FIG. 7, a region including an object 701 and a virtual position identifier 702 is a region 703. The region 703 is expanded outward based on preset margin values (where an up-and-down margin value is h, and a left- and right margin value is w), to obtain a gray region 704. A region including an object 705 and a virtual position identifier 706 is a region 707. The region 707 is expanded outward based on preset margin values (where an up-and-down margin value is h, and a left- and right margin value is w), to obtain a gray region 708.

When an aiming point approaches the virtual position identifier, the virtual position identifier is converted from a default state into an aimed state, and a form of the virtual position identifier is enlarged, to help a player aim and shoot. When the player successfully hits a target object, the virtual position identifier plays a dynamic flickering effect. When the player successfully destroys the target object, the virtual position identifier plays a dynamic destruction effect and disappears. FIG. 8 is a third schematic diagram of interaction in a virtual scene according to an embodiment of this disclosure. As shown in FIG. 8, a shooting prop 801, an aiming point 802 for aiming, an object 803, and a virtual position identifier 804 are displayed on an interactive interface 800. When the aiming point 802 for aiming is moved to a position of the virtual position identifier 804, the virtual position identifier 804 on the interactive interface 800 is converted into a virtual position identifier 805 shown on the interactive interface 810. A size of the virtual position identifier 805 is greater than a size of the virtual position identifier 804.

The size of the virtual position identifier is linearly related to a distance between the virtual position identifier and the shooting prop. For example, when the distance between the virtual position identifier and the shooting prop is 200 meters, the size of the virtual position identifier is 50 pixels (px). When the distance between the virtual position identifier and the shooting prop is 1200 meters, the size of the virtual position identifier is 40 pixels. A value range of the size of the virtual position identifier may be [30, 60]. If the distance between the virtual position identifier and the shooting prop is 2400 meters, the size of the virtual position identifier is 30 pixels, which reaches a minimum size. When the distance between the virtual position identifier and the shooting prop is 3000 meters, the size of the virtual position identifier is still 30 pixels.

For example, FIG. 9A is a fourth schematic diagram of interaction in a virtual scene according to an embodiment of this disclosure. FIG. 9A shows a shooting prop 901A, an aiming point 902A, an object 903A, and a virtual position identifier 904A. A distance L1 between the virtual position identifier 904A and the shooting prop 901A is 200 meters, and a size of the virtual position identifier 904A is 50 pixels. FIG. 9B is a fifth schematic diagram of interaction in a virtual scene according to an embodiment of this disclosure. FIG. 9B shows a shooting prop 901B, an aiming point 902B, an object 903B, and a virtual position identifier 904B. A distance L2 between the virtual position identifier 904B and the shooting prop 901B is 1200 meters, and a size of the virtual position identifier 904B is 40 pixels. FIG. 9C is a sixth schematic diagram of interaction in a virtual scene according to an embodiment of this disclosure. FIG. 9C shows a shooting prop 901C, an aiming point 902C, an object 903C, and a virtual position identifier 904C. A distance L3 between the virtual position identifier 904C and the shooting prop 901C is 2400 meters, and a size of the virtual position identifier 904C is 30 pixels. FIG. 9D is a seventh schematic diagram of interaction in a virtual scene according to an embodiment of this disclosure. FIG. 9D shows a shooting prop 901D, an aiming point 902D, an object 903D, and a virtual position identifier 904D. A distance L4 between the virtual position identifier 904D and the shooting prop 901D is 3000 meters, and a size of the virtual position identifier 904D is still 30 pixels.

The virtual position identifier is hidden if a distance between the virtual position identifier and a center of an object is less than or equal to a display radius of the object on the interactive interface. If the distance between the virtual position identifier and the center of the object is greater than the display radius of the object on the interactive interface, the virtual position identifier is displayed. For example, if the display radius of the object on the interactive interface is 60 pixels, and if the distance between the virtual position identifier and the center of the object is greater than 60 pixels, the virtual position identifier is displayed. If the distance between the virtual position identifier and the center of the object is less than or equal to 60 pixels, the virtual position identifier is not displayed, to prevent the virtual position identifier from blocking the object.

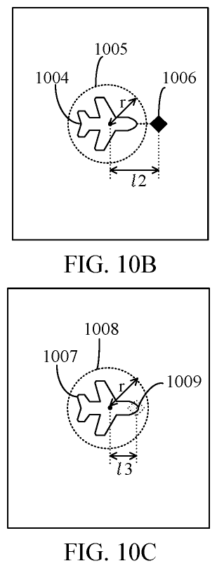

For example, FIG. 10A is an eighth schematic diagram of interaction in a virtual scene according to an embodiment of this disclosure. FIG. 10A shows an object 1001, a circular display range 1002 of the object 1001, and a virtual position identifier 1003. A radius of the circular display range 1002 of the object 1001 is r, and a distance between the virtual position identifier and a center of the object is l1. Because l1 is greater than r, the virtual position identifier 1003 is displayed. FIG. 10B is a ninth schematic diagram of interaction in a virtual scene according to an embodiment of this disclosure. FIG. 10B shows an object 1004, a circular display range 1005 of the object 1004, and a virtual position identifier 1006. A radius of the circular display range 1005 of the object 1004 is r, and a distance between the virtual position identifier and a center of the object is l2. Because l2 is greater than r, the virtual position identifier 1006 is displayed. FIG. 10C is a tenth schematic diagram of interaction in a virtual scene according to an embodiment of this disclosure. FIG. 10C shows an object 1007, a circular display range 1008 of the object 1007, and a virtual position identifier 1009. A radius of the circular display range 1008 of the object 1007 is r, and a distance between the virtual position identifier and a center of the object is l3. Because l3 is less than r, the virtual position identifier 1009 is hidden.

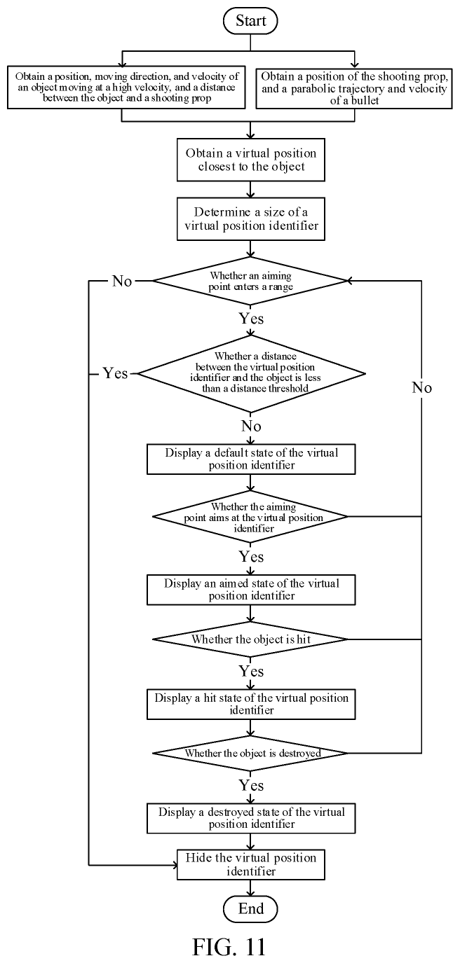

The following specifically describes a procedure of the interaction processing method for a virtual scene provided in the embodiments of this disclosure. FIG. 11 is a flowchart of interaction processing for a virtual scene according to an embodiment of this disclosure. As shown in FIG. 11, a position, moving direction, and velocity of an object moving at a high velocity, a distance between the object and a shooting prop, a position of the shooting prop, and a parabolic trajectory and velocity of a bullet are first obtained. Resolving is performed based on the obtained data, to determine a virtual position satisfying a resolving condition, which indicates that a player can hit the object by shooting the virtual position when the object maintains moving in a current state. If a resolving result is that a plurality of virtual positions simultaneously exist, a virtual position with a shortest hit time may be selected for shooting, that is, a virtual position closest to the object is obtained. In addition, a virtual position identifier is displayed at the virtual position, where a size of the virtual position identifier may be determined based on the distance between the object and the shooting prop.

For example, FIG. 12 is an eleventh schematic diagram of interaction in a virtual scene according to an embodiment of this disclosure. FIG. 12 shows a shooting prop 1201, an object 1202, and a virtual position identifier 1203. When the object 1202 maintains moving in a current state, a player can hit the object 1202 by shooting the virtual position identifier 1203 by using the shooting prop 1201.

Then, whether an aiming point of the shooting prop enters a region range of the object and the virtual position identifier is determined. When the aiming point of the shooting prop enters the region range of the object and the virtual position identifier, and a distance between the virtual position identifier and the object is greater than a distance threshold, a default state of the virtual position identifier and a dashed line between the virtual position identifier and the object are displayed on an interactive interface. When the aiming point of the shooting prop does not enter the region range of the object and the virtual position identifier, or when the aiming point of the shooting prop enters the region range of the object and the virtual position identifier, but the distance between the virtual position identifier and the object is less than the distance threshold, the virtual position identifier is not displayed on the interactive interface.

Herein, a size of the region range of the object and the virtual position identifier may be determined based on a size of a display range of the object and the virtual position identifier on the interactive interface. Based on the display range of the object and the virtual position identifier on the interactive interface, a margin of a preset size is expanded. For example, a left-and-right margin is expanded by 96 pixels, and an up-and-down margin is expanded by 24 pixels. Still referring to FIG. 7, w in FIG. 7 is 96 pixels, and his 24 pixels.

Then, whether the aiming point of the shooting prop aims at the virtual position identifier is determined. When it is detected that the aiming point of the shooting prop aims at the virtual position identifier, an aimed state of the virtual position identifier is displayed on the interactive interface. When the aiming point of the shooting prop does not aim at the virtual position identifier, the operation of determining whether the aiming point of the shooting prop enters the region range of the object and the virtual position identifier continues to be performed. Then, whether the shooting prop hits the object is determined. When it is detected that the shooting prop hits the object, a hit state of the virtual position identifier is displayed on the interactive interface. When the shooting prop does not hit the object, the operation of determining whether the aiming point of the shooting prop enters the region range of the object and the virtual position identifier continues to be performed. Finally, whether the shooting prop destroys the object is determined. When it is detected that the shooting prop destroys the object, a destroyed state of the virtual position identifier is displayed on the interactive interface, and the virtual position identifier is hidden. When the shooting prop does not destroy the object, the operation of determining whether the aiming point of the shooting prop enters the region range of the object and the virtual position identifier continues to be performed.

In this embodiment of this disclosure, the target virtual position is determined, with reference to the flight velocity and the parabolic trajectory of the bullet, based on the moving direction, the velocity, and the distance of the object moving at the high velocity, so that the user can shoot the virtual position to hit the object moving at the high velocity when the object maintains the current moving state, to help the user shoot the object moving at the high velocity, and enable the user to accurately hit the object without performing a long period of practice, thereby improving user experience.

An exemplary structure in which an implementation of the interaction processing apparatus 455 for the virtual scene provided in the embodiments of this disclosure is a software module continues to be described below. In some embodiments, as shown in FIG. 2, the software module in the interaction processing apparatus 455 for the virtual scene stored in the memory 450 may include:
a first display module 4551, configured to display a virtual scene, the virtual scene including a shooting prop and at least one virtual object;
a position update module 4552, configured to update, in response to an adjustment operation for a shooting direction of the shooting prop, a position of a reticle of the shooting prop based on the adjustment operation; and
a second display module 4553, configured to display a first predicted moving trajectory of a first virtual object in response to that a distance between the reticle and the first virtual object after the adjustment operation satisfies a distance condition; and display a first attack prompt identifier at a first end position of the first predicted moving trajectory, the first end position being a position that the first virtual object is to reach when maintaining a current moving state, the first attack prompt identifier being configured for prompting to attack the first end position by using the shooting prop, and the first virtual object being any one of the at least one virtual object.

In some embodiments, the position update module 4552 is further configured to determine a second position based on a first position at which the reticle is currently located, and an adjustment direction and an adjustment amplitude of the adjustment operation; move the reticle of the shooting prop from the current first position to the second position, the second position being an impact point of a projectile shot from the shooting prop based on the adjusted shooting direction; and display the reticle at the second position.

In some embodiments, the second display module 4553 is further configured to cancel, when the position of the reticle of the shooting prop is adjusted based on the adjustment operation, display of the first predicted moving trajectory and the first attack prompt identifier in response to that the distance between the reticle and the first virtual object after the adjustment operation does not satisfy the distance condition.

In some embodiments, a degree of prominence indicated by a display parameter of the first attack prompt identifier in a first state is higher than a degree of prominence indicated by a display parameter of the first attack prompt identifier in a second state. The first state indicates that a distance between the reticle and the first attack prompt identifier is less than or equal to a first distance threshold, and the second state indicates that the distance between the reticle and the first attack prompt identifier is greater than the first distance threshold.

In some embodiments, a size of the first attack prompt identifier is negatively correlated to a distance between the shooting prop and the first attack prompt identifier, and the size of the first attack prompt identifier is within a preset size range.

In some embodiments, the distance condition includes at least one of the following: the distance between the reticle and the first virtual object is less than a second distance threshold; or the distance between the reticle and the first virtual object is less than the second distance threshold, and a distance between the first attack prompt identifier and the first virtual object is greater than a third distance threshold.

In some embodiments, the second display module 4553 is further configured to: when the position of the reticle coincides with the first end position, in response to an attack trigger operation for the shooting prop, convert the first attack prompt identifier into a hit effect when the shooting prop hits the first virtual object, or convert the first attack prompt identifier into a destruction effect when the shooting prop destroys the first virtual object.

In some embodiments, the second display module 4553 is further configured to display, in response to an attack trigger operation for the shooting prop when the shooting prop does not hit the first virtual object and the first virtual object follows an evasion route after the shooting prop attacks, a second predicted moving trajectory of the first virtual object if a distance between the position of the reticle and the first virtual object in the evasion route satisfies the distance condition; and display a second attack prompt identifier at a second end position of the second predicted moving trajectory, the second end position being a position that the first virtual object is to reach when moving according to the second predicted moving trajectory, and the second attack prompt identifier being configured for prompting to attack the second end position by using the shooting prop.

In some embodiments, the second display module 4553 is further configured to: when the at least one virtual object includes a plurality of virtual objects, in response to that a distance between the position of the reticle and each of the plurality of virtual objects satisfies the distance condition, display a plurality of third predicted moving trajectories respectively corresponding to at least one second virtual object, and display a corresponding third attack prompt identifier at a third end position of each of the third predicted moving trajectories, the plurality of virtual objects including the first virtual object and the at least one second virtual object; and select a target attack prompt identifier from the plurality of third attack prompt identifiers, the target attack prompt identifier being configured for prompting to attack a third end position corresponding to the target attack prompt identifier by using the shooting prop.

In some embodiments, the second display module 4553 is further configured to determine, in response to a selection operation on one of the plurality of third attack prompt identifiers, the selected third attack prompt identifier as the target attack prompt identifier.

In some embodiments, the second display module 4553 is further configured to select one of the plurality of third attack prompt identifiers as the target attack prompt identifier based on a first preset condition, the first preset condition including selecting the third attack prompt identifier closest to the shooting prop.

In some embodiments, the second display module 4553 is further configured to obtain defense feature information of the second virtual object and attack feature information of the shooting prop; invoke a pre-trained machine learning model based on the defense feature information of the second virtual object and the attack feature information of the shooting prop, to obtain a hit probability of attacking the second virtual object by using the shooting prop; and determine the third attack prompt identifier corresponding to the second virtual object having a largest hit probability as the target attack prompt identifier.

In some embodiments, the second display module 4553 is further configured to obtain a training data set, the training data set including a plurality of groups of defense feature information samples of virtual object samples and attack feature samples of shooting prop samples, and label information indicating whether the shooting prop samples hit the corresponding virtual object samples; invoke an initialized machine learning model for prediction based on the plurality of groups of the defense feature information samples of the virtual object samples and the attack feature samples of the shooting prop samples, to obtain predicted probabilities of the shooting prop samples hitting the corresponding virtual object samples; determine a loss value by using a preset loss function based on differences between the predicted probabilities and the label information; and update a parameter of the initialized machine learning model by using a backpropagation algorithm based on the loss value, to obtain the pre-trained machine learning model.

In some embodiments, the second display module 4553 is further configured to display at least one fourth predicted moving trajectory of the first virtual object, and display a fourth attack prompt identifier at a fourth end position of each of the at least one fourth predicted moving trajectory; and determine, in response to a selection operation on any one of the first attack prompt identifier and the fourth attack prompt identifier, the selected attack prompt identifier as a target attack prompt identifier, the target attack prompt identifier being configured for prompting to attack the fourth end position by using the shooting prop.

In some embodiments, before the first attack prompt identifier is displayed at the first end position of the first predicted moving trajectory, the second display module 4553 is further configured to obtain a first constraint condition, the first constraint condition including that a difference between a first time taken by the first virtual object to move from a current position to a target position and a second time taken by the projectile of the shooting prop to fly to the target position is less than a time threshold, the first time being determined based on the current moving state of the first virtual object, and the second time being determined based on a distance between the shooting prop and the first virtual object, and a flight direction and a flight velocity of the projectile of the shooting prop; and determine the target position satisfying the first constraint condition as the first end position.

In some embodiments, before the first attack prompt identifier is displayed at the first end position of the first predicted moving trajectory, the second display module 4553 is further configured to obtain a second constraint condition, the second constraint condition including that a first time taken by the first virtual object to move from a current position to a target position is equal to a sum of second time and a third time, the second time being a time interval from display of the first attack prompt identifier to shooting of the shooting prop, and the third time being a time taken by the projectile of the shooting prop to fly to the target position; and determine the target position satisfying the second constraint condition as the first end position.

In some embodiments, when there are a plurality of target positions satisfying the second constraint condition, the second display module 4553 is further configured to perform either of the following processing: selecting any one of the plurality of target positions as the first end position; or selecting one of the plurality of target positions as the first end position based on a second preset condition, the second preset condition including selecting the target position closest to the shooting prop.

An embodiment of this disclosure provides a computer program product. The computer program product includes a computer program or computer-executable instructions. The computer program or the computer-executable instructions are stored in a non-transitory computer-readable storage medium. A processor of an electronic device reads the computer-executable instructions from the non-transitory computer-readable storage medium, and executes the computer-executable instructions, to enable the electronic device to perform the interaction processing method for a virtual scene in the embodiments of this disclosure.

An embodiment of this disclosure provides a non-transitory computer-readable storage medium, having computer-executable instructions or a computer program stored therein, the computer-executable instructions or the computer program, when being executed by a processor, enabling the processor to perform the interaction processing method for a virtual scene provided in the embodiments of this disclosure, for example, the interaction processing method for a virtual scene shown in FIG. 3A.

In some embodiments, the computer-readable storage medium may be a memory such as a random access memory (RAM), a read-only memory (ROM), a flash memory, a magnetic surface memory, an optical disc, or a compact disc read-only memory (CD-ROM), or may be any device including one or any combination of the foregoing memories.

In some embodiments, the computer-executable instructions may be in a form of a program, software, a software module, a script, or code, written in a programming language of any form (including a compiled or interpreted language, or a declarative or procedural language), and may be deployed in any form, including being deployed as a stand-alone program or as a module, a component, a subroutine, or another unit suitable for use in a computing environment.

For example, the computer-executable instructions may, but do not necessarily correspond to, a file in a file system, and may be stored as a part of a file having another program or data stored therein. For example, the computer-executable instructions are stored in one or more scripts in a hypertext markup language (HTML) text, stored in a single file dedicated to a discussed program, or stored in a plurality of collaborative files (for example, files having one or more modules, subprograms, or code parts).

For example, the computer-executable instructions may be deployed on an electronic device for execution, or may be executed on a plurality of electronic devices located at a same position. Alternatively, the computer-executable instructions are executed on a plurality of electronic devices that are connected through a communication network and that are distributed at a plurality of position.

In this embodiment of this disclosure, the shooting prop and the at least one virtual object are displayed in the virtual scene, the shooting direction of the shooting prop in the virtual scene is adjusted to dynamically adjust the position of the reticle, and the shooting direction and the position of the reticle are linked in real time, to address a problem of an aiming delay caused by “direction-reticle separation” in a shooting game in a related technology. A user can automatically synchronize the direction with the reticle without manually calibrating an offset of the reticle, so that operation complexity can be reduced. When a distance between the reticle and a virtual object satisfies the distance condition, a predicted moving trajectory of the virtual object is displayed. Trajectory prediction is triggered based on the distance condition, to implement intelligent aiming assistance, so that the user does not need to estimate a target moving path, and the trajectory is automatically calculated and displayed. In addition, an attack prompt identifier is displayed at an end position of the predicted moving trajectory, so that the predicted moving trajectory of the virtual object and the attack prompt identifier are more intuitively displayed. Depending on an auxiliary effect of the attack prompt identifier, the user can more clearly determine a to-be-shot target position when aiming by using the reticle of the shooting prop. In comparison with the related technology in which aiming is performed by using the reticle of the shooting prop, a user with less shooting experience can more easily hit an interaction efficiency, reducing occupation of resources of an electronic device, and improving user experience.

The foregoing descriptions are merely examples of embodiments of this disclosure, and are not intended to limit the scope of this disclosure. Any modification, equivalent replacement, and improvement made within the spirit and scope of this disclosure are included in the scope of this disclosure.

What is claimed is:

1. An interaction processing method for a virtual scene, the method comprising:
displaying the virtual scene of a game application and a reticle of a shooting prop at a first position, the virtual scene including at least one virtual object;
moving a reticle of a shooting prop from the first position to a second position based on an adjustment operation for a shooting direction of the shooting prop performed by a user of the game application;
determining whether a distance between the second position of the reticle and the first virtual object satisfy a distance condition;
displaying a first predicted movement trajectory of a first virtual object of the at least one virtual object based on the distance between the second position of the reticle and the first virtual object satisfying a distance condition; and
displaying a first attack prompt identifier at a first end position of the first predicted movement trajectory, the first virtual object being predicted to reach the first end position based on a current movement state, the first attack prompt identifier being configured to prompt the user to attack the first end position by using the shooting prop.

2. The method according to claim 1, wherein the moving comprises:
determining the second position based on the first position, and an adjustment direction and an adjustment amplitude of the adjustment operation; and
moving the reticle of the shooting prop from the first position to the second position, the second position being an impact point of a projectile shot from the shooting prop based on the adjusted shooting direction.

3. The method according to claim 1, wherein
the display of the first predicted movement trajectory and the first attack prompt identifier is canceled when the distance between the reticle and the first virtual object does not satisfy the distance condition.

4. The method according to claim 1, wherein
a degree of prominence of the first attack prompt identifier in a first state is higher than a degree of prominence of the first attack prompt identifier in a second state, wherein the first state indicates that a distance between the reticle and the first attack prompt identifier is less than or equal to a first distance threshold, and the second state indicates that the distance between the reticle and the first attack prompt identifier is greater than the first distance threshold.

5. The method according to claim 1, wherein
a size of the first attack prompt identifier is negatively correlated to a distance between the shooting prop and the first attack prompt identifier.

6. The method according to claim 1, wherein
the distance condition includes the distance between the reticle and the first virtual object is less than a second distance threshold, and a distance between the first attack prompt identifier and the first virtual object is greater than a third distance threshold.

7. The method according to claim 1, wherein when the position of the reticle coincides with the first end position, the method further comprises:
based on an attack trigger operation for the shooting prop, converting the first attack prompt identifier into an effect when the shooting prop hits the first virtual object.

8. The method according to claim 1, further comprising:
displaying, based on an attack trigger operation for the shooting prop when the shooting prop does not hit the first virtual object and the first virtual object follows an evasion route after the shooting prop attacks, a second predicted movement trajectory of the first virtual object when a distance between the position of the reticle and the first virtual object in the evasion route satisfies the distance condition; and
displaying a second attack prompt identifier at a second end position of the second predicted movement trajectory, the first virtual object being predicted to reach to the second end position based on the second predicted movement trajectory, and the second attack prompt identifier being configured to prompt the user to attack the second end position by using the shooting prop.

9. The method according to claim 1, wherein when the at least one virtual object includes the first virtual object and a second virtual object, the method further comprises:
when a distance between the position of the reticle and the second virtual object satisfies the distance condition, displaying a third predicted movement trajectory corresponding to the second virtual object, and displaying a corresponding third attack prompt identifier at a third end position of the third predicted movement trajectory.

10. The method according to claim 9, wherein when the at least one virtual object includes the first virtual object and the second virtual object, the method further comprises:
determining a target attack prompt identifier based on a selection operation on one of the first attack prompt identifier and the third attack prompt identifier.

11. The method according to claim 9, wherein when the at least one virtual object includes the first virtual object and the second virtual object, the method further comprises:
selecting a target attack prompt identifier based on which one of the first attack prompt identifier and the third attack prompt identifier is closest to the shooting prop.

12. The method according to claim 9, wherein when the at least one virtual object includes the first virtual object and the second virtual object, the method further comprises:
obtaining defense feature information of the second virtual object and attack feature information of the shooting prop;
invoking a pre-trained machine learning model based on the defense feature information of the second virtual object and the attack feature information of the shooting prop, to obtain a hit probability of attacking the second virtual object by using the shooting prop; and
determining the third attack prompt identifier corresponding to the second virtual object having a largest hit probability as a target attack prompt identifier.

13. The method according to claim 12, wherein the pre-trained machine learning model is obtained by:
obtaining a training data set, the training data set including a plurality of groups of defense feature information samples of virtual object samples and attack feature samples of shooting prop samples, and label information indicating whether the shooting prop samples hit the corresponding virtual object samples;
invoking an initialized machine learning model for prediction based on the plurality of groups of the defense feature information samples of the virtual object samples and the attack feature samples of the shooting prop samples, to obtain predicted probabilities of the shooting prop samples hitting the corresponding virtual object samples;
determining a loss value by using a preset loss function based on differences between the predicted probabilities and the label information; and
updating a parameter of the initialized machine learning model by using a backpropagation algorithm based on the loss value, to obtain the pre-trained machine learning model.

14. The method according to claim 1, further comprising:
displaying at least one fourth predicted movement trajectory of the first virtual object, and displaying a fourth attack prompt identifier at a fourth end position of each of the at least one fourth predicted movement trajectory; and
determining, based on a selection operation on any one of the first attack prompt identifier and the at least one fourth attack prompt identifier, a target attack prompt identifier.

15. The method according to claim 1, further comprising:
obtaining a first constraint condition, the first constraint condition including a difference between a first time taken by the first virtual object to move from a current position to a target position and a second time taken by a projectile of the shooting prop to reach the target position is less than a time threshold, the first time being determined based on the current moving state of the first virtual object, and the second time being determined based on a distance between the shooting prop and the first virtual object, and a movement direction and a movement velocity of the projectile of the shooting prop; and
determining the target position satisfying the first constraint condition as the first end position.

16. The method according to claim 1, further comprising:
obtaining a second constraint condition, the second constraint condition including a first time taken by the first virtual object to move from a current position to a target position is equal to a sum of second time and a third time, the second time being a time interval from display of the first attack prompt identifier to shooting of the shooting prop, and the third time being a time taken by a projectile of the shooting prop to reach the target position; and
determining the target position satisfying the second constraint condition as the first end position.

17. The method according to claim 16, wherein when there are a plurality of target positions satisfying the second constraint condition, the method further comprises:
selecting any one of the plurality of target positions as the first end position.

18. An interaction processing apparatus, comprising:
processing circuitry configured to:
display a virtual scene of a game application and a reticle of a shooting prop at a first position, the virtual scene including at least one virtual object;
move a reticle of a shooting prop from the first position to a second position based on an adjustment operation for a shooting direction of the shooting prop performed by a user of the game application;
determine whether a distance between the second position of the reticle and the first virtual object satisfy a distance condition;
display a first predicted movement trajectory of a first virtual object of the at least one virtual object based on the distance between the second position of the reticle and the first virtual object satisfying a distance condition; and
display a first attack prompt identifier at a first end position of the first predicted movement trajectory, the first virtual object being predicted to reach the first end position based on a current movement state, the first attack prompt identifier being configured to prompt the user to attack the first end position by using the shooting prop.

19. The interaction processing apparatus according to claim 18, wherein the processing circuitry is configured to:
determine the second position based on the first position, and an adjustment direction and an adjustment amplitude of the adjustment operation; and
move the reticle of the shooting prop from the first position to the second position, the second position being an impact point of a projectile shot from the shooting prop based on the adjusted shooting direction.

20. A non-transitory computer-readable storage medium storing instructions which when executed by a processor cause the processor to perform:
displaying a virtual scene of a game application and a reticle of a shooting prop at a first position, the virtual scene including at least one virtual object;
moving a reticle of a shooting prop from the first position to a second position based on an adjustment operation for a shooting direction of the shooting prop performed by a user of the game application;
determining whether a distance between the second position of the reticle and the first virtual object satisfy a distance condition;
displaying a first predicted movement trajectory of a first virtual object of the at least one virtual object based on the distance between the second position of the reticle and the first virtual object satisfying a distance condition; and
displaying a first attack prompt identifier at a first end position of the first predicted movement trajectory, the first virtual object being predicted to reach the first end position based on a current movement state, the first attack prompt identifier being configured to prompt the user to attack the first end position by using the shooting prop.
